(19) United States
(12) Patent Application Publication
(10) Pub. No.: US 2025/0238445 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Yoshihisa IJIRI, Tokyo (JP); Junichi SATO, Tokyo (JP); Takahiro ISHIKAWA, Tokyo (JP)

(21) Appl. No.: 18/973,478

(22) Filed: Dec. 9, 2024

(30) Foreign Application Priority Data
Jan. 19, 2024 (JP) 2024-007012

(51) Int. Cl. G06F 16/3329; G06N 20/20

(52) U.S. Cl. CPC G06F 16/33295; G06N 20/20

(57) ABSTRACT

An information processing apparatus according to the present application includes a reception unit, a selection unit, and a providing unit. The reception unit receives a query including a prompt sent from a user or a query for obtaining the prompt. The selection unit selects, based on information on a plurality of items included in the prompt, AI that is used to generate response information indicating a response to the prompt from among a plurality of pieces of AI. The providing unit provides the response information that has been generated by using the AI selected by the selection unit to the user.

### CROSS-REFERENCE TO RELATED APPLICATIONS

The present application claims priority to and incorporates by reference the entire contents of Japanese Patent Application No. 2024-007012 filed in Japan on Jan. 19, 2024.

### BACKGROUND OF THE INVENTION

### 1. Field of the Invention

The present invention relates to an information processing apparatus, an information processing method, and a non-transitory computer readable storage medium having stored therein an information processing program.

### 2. Description of the Related Art

In recent years, there is a known technology for generating information by using AI, such as generative AI. For example, Japanese Patent No. 7313757 discloses a technology for using large language models (LLMs) and generating a prompt in which a sentence effective for an input question text is added as reference information within the range of character limit. The prompt is information that is input to the generative AI, and that indicates, for example, an instruction, a request, or the like provided to the generative AI in order to perform a specific task on the generative AI.

However, in the conventional technology described above, there is a possibility that a response to the prompt is not able to be appropriately obtained in accordance with training circumstances of AI, such as generative AI.

### SUMMARY OF THE INVENTION

An information processing apparatus according to the present application includes a reception unit, a selection unit, and a providing unit. The reception unit receives a query including a prompt sent from a user or a query for obtaining the prompt. The selection unit selects, based on information on a plurality of items included in the prompt by the reception unit, AI that is used to generate response information indicating a response to the prompt from among a plurality of pieces of AI. The providing unit provides the response information that has been generated by using the AI selected by the selection unit to the user.

### BRIEF DESCRIPTION OF THE DRAWINGS

FIG. 1 is a diagram illustrating information processing according to an embodiment;

FIG. 2 is a diagram illustrating one example of a configuration of an information processing system according to the embodiment;

FIG. 3 is a diagram illustrating one example of a configuration of an information processing apparatus according to the embodiment;

FIG. 4 is a diagram illustrating one example of a user information table stored in a user information storage unit included in the information processing apparatus according to the embodiment;

FIG. 5 is a diagram illustrating one example of a past prompt table stored in a past prompt storage unit included in the information processing apparatus according to the embodiment;

FIG. 6 is a diagram illustrating one example of a generation related information table stored in a generation related information storage unit included in the information processing apparatus according to the embodiment;

FIG. 7 is a flowchart illustrating one example of information processing performed by a processing unit included in the information processing apparatus according to the embodiment;

FIG. 8 is a diagram illustrating another example of a configuration of the information processing apparatus according to the embodiment; and

FIG. 9 is a hardware configuration diagram illustrating one example of a computer that implements a function of the information processing apparatus according to the embodiment.

### DETAILED DESCRIPTION OF THE PREFERRED EMBODIMENTS

Modes (hereinafter, referred to as an “embodiments”) for carrying out an information processing apparatus, an information processing method, and a non-transitory computer readable storage medium having stored therein an information processing program according to the present application will be described in detail below with reference to the accompanying drawings. the information processing apparatus, the information processing method, and the non-transitory computer readable storage medium having stored therein an information processing program according to the present application are not limited by the embodiments. Furthermore, in the embodiments below, the same components are denoted by the same reference numerals and an overlapping description will be omitted.

### [1. One Example of Information Processing]

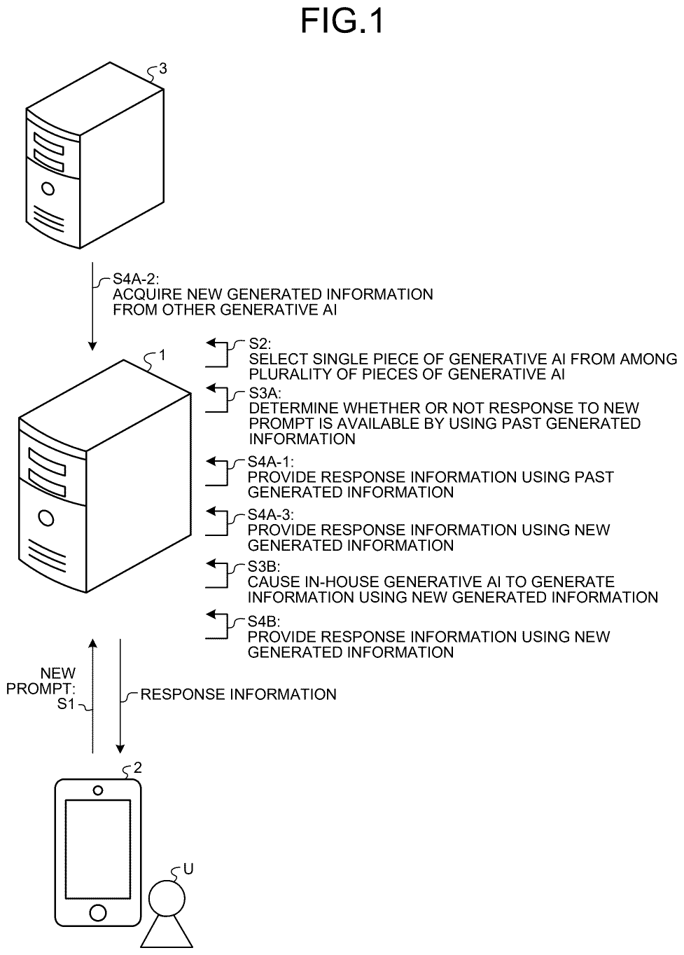

First, one example of information processing according to the embodiment will be described with reference to FIG. 1. FIG. 1 is a diagram illustrating the information processing according to the embodiment.

An information processing apparatus 1 illustrated in FIG. 1 is an information processing apparatus that provides various kinds of information online to users U, in cooperation with each of terminal devices 2 used by the respective users, and is implemented by, for example, one or more servers, a cloud system, or the like. Each of the terminal devices 2 is, for example, a smartphone, a tablet computer, a personal computer, or the like.

The information processing apparatus 1 includes a plurality of pieces of generative artificial intelligence (AI), and is able to provide information by using the plurality of pieces of generative AI. The plurality of pieces of generative AI included in the information processing apparatus 1 are managed by an operator of the information processing apparatus 1, and, in a description below, the generative AI included in the information processing apparatus 1 is sometimes referred to as in-house generative AI. The in-house generative AI is one example of first generative AI.

Furthermore, the information processing apparatus 1 is able to use the generative AI via an application programming interface (API) that is used for the generative AI operated in an information processing apparatus 3. In a description below, the generative AI included in the information processing apparatus 3 is sometimes referred to as the other company generative AI, and an API that is used for the generative AI is sometimes referred to as a generative AI-API. The information processing apparatus 3 is one example of the other information processing apparatus, and the other company generative AI is one example of second generative AI.

The generative AI is, for example, text generative AI, image generative AI, or multimodal generative AI. The text generative AI is a large language model that has been trained to, for example, estimate a next token from an input token string and output the estimated token, and is, for example, a transformer based model, a recurrent neural network (RNN) based model, or the like, or may also be a mixed model of these models. Furthermore, the text generative AI may also be a complex system constituted in combination with an identification device that is used to prevent unauthorized use.

The transformer based model is, for example, a generative pre-trained transformer (GPT), Pathways Language Model Version 2 (PaLM2), or the like, but is not limited to these examples. The RNN based model is a receptance weighted key value (RWKV), or the like, but is not limited to this example.

The image generative AI is AI that generates an image from a text, and is, for example, Generative Adversarial Networks (StackGAN), AttnGAN, T2I (Text-to-Image) with Transformers, a diffusion model, or the like, but the example is not limited to this example. Examples of the Diffusion model include DALL-E, Stable-Diffusion, and the like.

The multimodal generative AI is generative AI that generates at least one of a text, an image, and audio from at least one of, for example, the text, the image, and the audio. The multimodal generative AI is, for example, GPT-4 Turbo with vision, gemini, CM3Leon (Chameleon Multimodal Model), or the like, but is not limited to these example.

Moreover, it is preferable that the above described generative AI is trained such that personal information or the like is not included in the generated result.

As illustrated in FIG. 1, the information processing apparatus 1 receives a query including a new prompt that is a prompt newly sent from the user U (Step S1). The user U is able to input or select the prompt by operating the terminal device 2, and, as a result of this, a use request including the new prompt is transmitted from the terminal device 2 to the information processing apparatus 1. The information processing apparatus 1 receives the new prompt included in the use request by receiving the use request sent from the terminal device 2. The use request is one example of the query.

Subsequently, in a case where the information processing apparatus 1 receives the query including the new prompt at Step S1, the information processing apparatus 1 selects a single piece of generative AI from among the plurality of pieces of generative AI including the in-house generative AI and the other company generative AI (Step S2).

For example, the information processing apparatus 1 selects the generative AI that is used to generate response information indicating a response to the new prompt on the basis of information on a plurality of items included in the new prompt from among the plurality of pieces of generative AI including the in-house generative AI and the other company generative AI.

Each of the plurality of items is an item indicating a category of a matter corresponding to a key or a matter corresponding to a characteristic, and is an item indicating a meaning category of, for example, a semantic field, or the like. Furthermore, the information on the item is the information that indicates an item (the information that indicates an item itself) or information that indicates the content of the item. The information that indicates the content of the item is the information that indicates the content of the matter corresponding to the key, the information that indicates the content of the matter corresponding to the characteristic, or the like.

The information processing apparatus 1 extracts the information on the plurality of items included in the new prompt by using a technology of slot filtering, or the like. In the slot filtering, each of the items is referred to as a slot, but each of the items is not limited to the slot, but may be any item as long as, as described above, the item indicates the category of the matter corresponding to a key or the matter corresponding to a characteristic.

For example, it is assumed that the new prompt is a prompt that is input to the generative AI in order to generate a piece of advertising content. In this case, the new prompt is information on, for example, a character string indicating that “Please create advertising content of grand opening of an organic coffee shop characterized by a cozy interior. The advertising content should be designed to target the local community.”

In this case, the information on the plurality of items included in the new prompt is the information that indicates the content of the items, such as the information on the character string of “cozy interior”, the information on the character string of “grand opening”, the information on the character string of “organic coffee shop”, and the information on the character string of “local community”. The information on the character string of “cozy interior” is the information indicating the content of the item of “design of an inside of the store”, and the information on the character string of “grand opening” is the information indicating the content of the item of “state of the store”.

Furthermore, the information on the character string of “organic coffee shop” is the information indicating the content of the item of “category of the store”, and the information on the character string of “local community” is the information indicating the content of the item of “place of residence of a target user”. The information on the item of “place of residence of the target user” is one example of the information indicating the attribute of the user U who is the target user.

Furthermore, the information on the plurality of items included in the new prompt may be, instead of or in addition to the information indicating the content of the item, for example, information indicating an item of “location of the store”, information indicating an item of “event”, information indicating an item of “coupon or a discount”, information indicating an item of “product price”, information indicating an item of “age group of the target user”, information indicating an item of “interest held by the target user”, or the like.

Furthermore, the information on the item may be, for example, information on an item of “tone of voice”, information on an item of “prompt format”, or the like. The information that indicates the content of the item of “tone of voice” is information on, for example, a direct command indicating “Do”, or the like, or an indirect command indicating “Please do”, or the like. The information that indicates the content of the item of “prompt format” is information on, for example, zero-shot (Zero-shot), one-shot (One-shot), few-shot (Few-shot), or the like.

The information processing apparatus 1 extracts pieces of information that indicate the plurality of respective items from the new prompt on the bases of, for example, a rule base. For example, the information processing apparatus 1 includes dictionary information including a plurality of terms for each item, and is able to extract the information that is related to the plurality of items from the new prompt by using the dictionary information.

Furthermore, the information processing apparatus 1 includes an extraction model that extracts information on the plurality of items included in the new prompt, and is also able to extract the information that is related to the plurality of items included in the new prompt by using the extraction model.

The extraction model is a model that has been trained to extract the information on the plurality of items from the prompt, and is a model that has been trained to extract the information on the plurality of items from the prompt by using the learning purpose information that includes, for each prompt, a combination of a prompt and the information on the plurality of items included in the prompt. The extraction model is, for example, a Long Short-Term Memory (LSTM) or a Transformer based model, but may also be the above described generative AI, or may be any other model.

Furthermore, the information processing apparatus 1 is also able to extract the information on the plurality of items from the new prompt by using a language model, such as the text generative AI. For example, the information processing apparatus 1 is able to cause the text generative AI to extract the information on the plurality of items by inputting, to the text generative AI, the information that includes both of the instruction information that indicates an instruction to extract the information on the plurality of items from the new prompt and the new prompt.

Furthermore, the information on the plurality of items is associated with each of the plurality of pieces of generative AI including the in-house generative AI and the other company generative AI. The information processing apparatus 1 is able to select the generative AI that is used to generate the response information from among the plurality of pieces of generative AI on the basis of a comparison result between the information on the plurality of items associated with the plurality of respective pieces of generative AI and the information on the plurality of items included in the new prompt.

For example, the information processing apparatus 1 selects, from among the plurality of pieces of generative AI, the generative AI having the highest degree of coincidence between the associated information on the plurality of items and the information on the plurality of items included in the new prompt. The degree of coincidence is, for example, the number of the pieces of associated information on the plurality of items and the information on the plurality of items included in the new prompt, a ratio of coincidence, or a value obtained by performing weighted addition on these results, but may also be a value obtained by adding the weight of the coincident items in a case where different weighting is applied to each of the items.

Furthermore, the information processing apparatus 1 is also able to select, from among the plurality of pieces of generative AI, the generative AI in which the degree of coincidence between the associated information on the plurality of items and the information on the plurality of items included in the new prompt is equal to or greater than a threshold. In this case, in a case where a plurality of pieces of generative AI, in which the degree of coincidence between the associated information on the plurality of items and the information on the plurality of items included in the new prompt is equal to or greater than the threshold, is present, the information processing apparatus 1 randomly selects or selects in accordance with the rule that has been defined in advance a single piece of generative AI from among these pieces of generative AI.

Furthermore, the information processing apparatus 1 is also able to select the generative AI that is used to generate the response information that indicates the response to the new prompt from among the plurality of pieces of generative AI on the basis of both of the context of the user U and the information on the plurality of items included in the new prompt.

For example, the context may be associated with each of the plurality of pieces of generative AI, in addition to the information on the plurality of items. In this case, the information processing apparatus 1 selects the generative AI that is used to generate the response information that indicates the response to the new prompt on the basis of the comparison result between a combination of the information on the plurality of items associated with the plurality of respective pieces of generative AI and the context and a combination of the information on the plurality of items included in the new prompt and the context of the user.

For example, the information processing apparatus 1 selects, from among the plurality of pieces of generative AI, the generative AI having the highest degree of coincidence between a combination of the associated information on the plurality of items and the context and a combination of the information on the plurality of items included in the new prompt and the context of the user U.

In a case where the context includes a plurality of elements, the degree of coincidence of the context is the number of elements that are coincident with each other, the rate of coincident elements, or a value obtained by performing weighted addition on these results, but, in a case where different weighting is applied to each of the elements, the degree of coincidence of the context may also be a value obtained by adding the weight of the coincident elements. The information processing apparatus 1 selects, from among the plurality of pieces of generative AI, the generative AI having the highest value obtained by performing weighted addition on the degree of coincidence of the plurality of items and the degree of coincidence of the context.

Furthermore, the information processing apparatus 1 is also able to select, from among the plurality of pieces of generative AI, the generative AI in which the degree of coincidence between the combination of the associated information on the plurality of items and the context and the combination of the information on the plurality of items included in the new prompt and the context of the user U is equal to or greater than the threshold.

In this case, in a case where there are a plurality of pieces of generative AI in which the degree of coincidence between the combination of the associated information on the plurality of items and the context and the combination of the information on the plurality of items included in the new prompt and the context of the user U is equal to or greater than the threshold, the information processing apparatus 1 randomly selects or selects in accordance with the rule that has been defined in advance a single piece of the generative AI from among these pieces of generative AI.

The context of the user U is the context obtained when the advertising content is provided to the user U by the information processing apparatus 1. The context of the user U is the current circumstances surrounding the user U, the circumstances surrounding the user U, or the like.

For example, the element of the context of the user U includes the attribute of the user, the current location of the user U, the current time, a physical environment in which the user U is placed, a social environment in which the user U is placed, a state of motion of the user U, a feeling of the user U, and the like. The attribute of the user U is, for example, a demographic attribute, a psychographic attribute, or the like.

The demographic attribute is an attribute in terms of a demographic characteristic, and includes a plurality of attribute elements of, for example, age, gender, an occupation, a place of residence, an annual income, a family structure, and the like. The psychographic attribute is an attribute in terms of a psychological characteristic, and includes a plurality of attribute elements related to, for example, interests and concerns, a life style, a sense of values, and the like. In a case where that attribute is the demographic attribute, the attribute of the user U is, for example, gender, age (age group), a place of residence, and an occupation, or a combination of two or more of these elements or the like, but is not limited to this example.

The physical environment in which the user U is placed is, for example, temperature, humidity, weather, illuminance, indoor, or outdoor, or a combination of two or more of these elements, but is not limited to this example. The social environment in which the user U is placed is, for example, an economic situation, a political situation, a popular product or service, or a combination of two or more of these elements or the like, but is not limited to this example.

The state of motion of the user U is, for example, a running situation, a walking situation, a sitting situation, or the like, but is not limited to this example. Furthermore, the feeling of the user U is, for example, a smiling situation, an angry situation, a troubling situation, or the like, but is not limited to this example.

Moreover, the context of the user U may be, for example, a combination of two or more of contexts among the attribute of the user U, the current location of the user U, the current time, the physical environment in which the user U is placed, the social environment in which the user U is placed, the state of motion of the user U, and the feelings of the user U.

The information processing apparatus 1 is able to acquire the information that indicates the attribute of the user U and that is associated with the identification information on the user U included in the use request from a storage unit that is provided in the information processing apparatus 1 or from an information processing apparatus that is provided outside. The identification information on the user U is, for example, an identifier (ID) of the user U, a browser cookie (cookie) of the terminal device 2, or the like, but is not limited to this example.

Furthermore, the information processing apparatus 1 is able to acquire the information that indicates the physical environment in which the user U is placed, the information that indicates the social environment in which the user U is placed, the information that indicates the current location of the user U, the information that indicates the state of motion exhibited by the user U, the information that indicates the feeling of the user U, or the like from the terminal device 2, an information processing apparatus that is provided outside, or the like.

Furthermore, the information processing apparatus 1 includes the selection model that selects a single piece of generative AI between the in-house generative AI and the other company generative AI and that has been obtained by being trained, and is also able to select one of the pieces of generative AI between the in-house generative AI and the other company generative AI by using the selection model.

For example, the information processing apparatus 1 is able to generate the selection model by using, as the learning purpose information, the information that includes, for each prompt, both of the information on the prompt and the information that indicates an evaluation performed, by the user U, on the provided information that has been generated by using the generative AI on the basis of the information including this prompt and that has been provided to the user U.

In this case, the information on the prompt is the prompt or a plurality of terms included in the prompt. The information that indicates the evaluation is an evaluation value obtained using, for example, an evaluation indicated on a scale of 5. The information that indicates the evaluation is used to generate the selection model by multiplying +1 by one of the evaluation value obtained when the in-house generative AI is used and the evaluation value obtained when the other company generative AI is used, and by multiplying −1 by the other of the evaluation values, for example. The provided information is the generated information that was generated using the generative AI in the past or is the information based on this generated information.

The information processing apparatus 1 inputs the information on the new prompt to the selection model, and determines whether the in-house generative AI is used or the other company generative AI is used in accordance with whether the value that is output from the selection model is a positive value or a negative value.

Furthermore, the information processing apparatus 1 may also include a selection model that is a model that determines whether or not a response to the new prompt is available by using the generated information that is generated by using the in-house generative AI and is a model that is obtained by being trained. In this case, the information processing apparatus 1 is also able to determine, by using the selection model, whether or not a response to the new prompt is available by using the generated information that is generated by using the in-house generative AI.

The selection model is a model that has been trained by using the learning purpose information that includes, for each prompt, for example, the prompt that was input to the in-house generative AI in the past and the evaluation information that indicates the evaluation performed, by the user U, on the provided information that has been generated by using that prompt. The evaluation information is the information that indicates the evaluation performed by the user U who provides, as the provided information, the generated information that has been generated by using the in-house generative AI or the information based on that generated information, and is the information that indicates the evaluation value obtained using, for example, an evaluation indicated on a scale of 5.

In this case, in a case where a new prompt or each of the terms included in the new prompt is input to the selection model, if the value output from the selection model is equal to or greater than the threshold, the information processing apparatus 1 determines that a response to the new prompt is available by using the generated information that is generated by using the in-house generative AI.

Furthermore, in the information processing apparatus 1, in a case where a plurality of pieces of in-house generative AI are present, the selection model may be a model that outputs a value (score) for each of the pieces of in-house generative AI in response to an input of the new prompt or each of the terms included in the new prompt. The information processing apparatus 1 is able to select the in-house generative AI that is associated with a value that is output from the selection model and that is equal to or greater than the threshold and a value that is the highest value.

Moreover, in a case where the information that assigns the generative AI is included in the use request, the information processing apparatus 1 is also able to select the generative AI assigned by the use request from among the plurality of pieces of generative AI.

In a case where the information processing apparatus 1 selects, at Step S2, the other company generative AI from among the plurality of pieces of generative AI, the information processing apparatus 1 determines whether or not a response to the new prompt is available by using the past generated information that is the information generated by using the other company generative AI in the past (Step S3A). The past generated information is one example of the existing information.

For example, the information processing apparatus 1 determines whether or not a response to the new prompt is available by using the past generated information on that basis of the prompt comparison result that is the result of the comparison between a past prompt that is the former prompt that has been used to generate the past generated information and the new prompt.

The information processing apparatus 1 calculates a score that indicates the comparison result obtained by comparing the former prompt that has been used to generate the past generated information with the new prompt, and determines, if the calculated score satisfies a predetermined condition (for example, in a case where the score is equal to or greater than the threshold or is equal to or less than the threshold), that the response to the new prompt is available. The score that indicates the comparison result between the former prompt and the new prompt is indicated by, for example, a degree of similarity or a degree of difference between the vectorized prompts. The prompts are vectorized by, for example, embedding, or the like performed by a sentence embedding model (for example, a transformer based model).

The embedding obtained by using the sentence embedding model is embedding performed by using, for example, text-embedding-ada, BERT, or the like provided by OpenAI company, but is not limited by this example. Moreover, vectorization performed on content is not limited to embedding obtained by using the sentence embedding model, but vectorization on content may be performed by using, for example, Doc2Vec, an average of word embedding, or the like. For word embedding, for example, Word2Vec embedding, fastText, or the like is used.

The information processing apparatus 1 performs vectorization on each of the past prompts, and performs vectorization on a new prompt. Then, the information processing apparatus 1 determines whether or not a past prompt in which a degree of similarity with the new prompt is equal to or greater than a threshold is present, or a past prompt in which a degree of difference with the new prompt is equal to or less than a threshold is present. If the information processing apparatus 1 determines that the past prompt in which the degree of similarity with the new prompt is equal to or greater than the threshold is present or determines that the past prompt in which the degree of difference with the new prompt is equal to or less than the threshold is present, the information processing apparatus 1 determines that the response to the new prompt is available by using the past generated information that has been generated by using the generative AI using that past prompt.

The degree of similarity between the new prompt and the past prompt is a cosine degree of similarity, but may also be a Jaccard degree of similarity, or the like, or may also be a reciprocal of the Euclidean distance, a reciprocal of the Manhattan distance, or the like. Furthermore, the degree of similarity between the new prompt and the past prompt is, for example, a reciprocal of the degree of similarity between the new prompt and the past prompt.

Furthermore, the information processing apparatus 1 is also able to extract the information on the plurality of items from the past prompt. The information processing apparatus 1 is able to extract the information on the plurality of items from each of the past prompts by using the dictionary information, the extraction model, or the generative AI described above.

In this case, in the case where the information processing apparatus 1 determines that there is the past prompt in which the degree of coincidence with the information on the plurality of items included in the new prompt is equal to or greater than the threshold, the information processing apparatus 1 determines that a response to the new prompt is available by using the past generated information that has been generated by using the generative AI using that past prompt.

Furthermore, the information processing apparatus 1 includes a determination model that determines whether or not a response to the new prompt is available by using the past generated information and that is obtained by being trained, and is also able to determine whether or not the response to the new prompt is available by using that determination model.

For example, the information processing apparatus 1 is able to generate the determination model by using, as the learning purpose information, the information that includes, for each prompt, both of the information on the prompt and the information that indicates the evaluation performed, by the user U, on the provided information that has been generated by using the other company generative AI on the basis of the information including the prompt and that has been provided by the user U.

In this case, the information on the prompt is a prompt or the plurality of terms included in the prompt. The information that indicates the evaluation is an evaluation value obtained using, for example, an evaluation indicated on a scale of 5. The provided information is the past generated information that has been generated by using the other company generative AI or is the information based on this past generated information.

The information processing apparatus 1 inputs the information on the new prompt to the determination model, and determines that, if the value that is output from the subject determination model is equal to or greater than the threshold, a response to the new prompt is available by using the past generated information.

In the case where the information processing apparatus 1 determines that the response to the new prompt is available by using the past generated information, the information processing apparatus 1 decides the past generated information that is associated with the past prompt having the highest degree of similarity or the highest degree of coincidence with the new prompt. The past generated information associated with the past prompt is the information that has been generated by the other company generative AI when the information including the past prompt is input to the other company generative AI in the past.

In a case where the information processing apparatus 1 has selected the other company generative AI from among the plurality of pieces of generative AI at Step S2 and determines that the response with respect to the new prompt is available by using the past generated information, the information processing apparatus 1 provides, to the user U, the information based on the past generated information or the past generated information as the response information that indicates the response to the new prompt (Step S4A-1). In this case, the past generated information is the generated information that is output from the other company generative AI in the past as a result of the information including the target prompt being input to the other company generative AI as the input information.

The target prompt is the past prompt in which a degree of similarity of the vector with the new prompt is equal to or greater than the threshold or the past prompt in which a degree of coincidence with the information on the plurality of items is equal to or greater than the threshold. In a case where a plurality of past prompts in which the degree of similarity or the degree of coincidence is equal to or greater than the threshold are present, the target prompt is the past prompt having the highest degree of similarity or the highest degree of coincidence, or is the past prompt that has been randomly selected or selected in accordance with the rule that has been defined in advance from among the plurality of past prompts in which the degree of similarity or the degree of coincidence is equal to or greater than the threshold.

Moreover, the target prompt may be the past prompt in which the score obtained by performing weighted addition on the degree of similarity and the degree of coincidence is equal to or greater than the threshold. In this case, in a case where the past prompt in which the score is equal to or greater than the threshold is present, at Step S3A, the information processing apparatus 1 determines that the response to the new prompt is available by using the past generated information.

The past generated information is the information that is output from the other company generative AI in a case where the information including the prompt received from the user U is input to the other company generative AI, but, in a case where the prompt received from the user U is a scenario, or the like, the past generated information may also be the information that is output from the other company generative AI by repeatedly input, to the other company generative AI, a dialogue history that includes both of the subject prompt and the history of the information output from the other company generative AI.

The scenario includes some of or all of the information on the character string that indicates, for example, the definition of the task performed by the generative AI, a constrained condition of the task performed in the generative AI, the definition of a behavior or a tone of the generative AI, an output format of the generative AI, and the like, but is not limited to these examples.

The information based on the past generated information is information collected by the information processing apparatus 1 or the information processing apparatus 3 on the basis of the information that indicates the intention category and the information that indicates the intention content, in a case where, for example, the past generated information is the intention information that includes both of the information indicating the intention category and the information indicating the intention content.

The intention category is, for example, a category of an intention of additional information, and the information that indicates the intention category is the information for specifying, for example, a mathematical function or a function according to the intention category. Furthermore, the intention content is the content of the intention of the additional information, and information that indicates the intention content is the information that indicates, for example, an argument of the mathematical function or the parameter for the function in accordance with the intention category.

The other company generative AI outputs the intention information in a case where the information that includes intention definition information for extracting both of the intention category and the intention content is input to the input information, in addition to the prompt input from the user U. The information processing apparatus 1 is able to cause the other company generative AI to generate the intention information by using a function of function calling, in a case where the generative AI-API is an API provided by OpenAI (registered trademark) company.

Furthermore, the information based on the past generated information or the past generated information may be the information that is output from the other company generative AI by inputting, to the other company generative AI, the information that includes both of the collection information that is the information collected as described above and the instruction information for instructing a process to be performed on such collection information. Moreover, the information based on the past generated information is the information that was generated in the past, but may also be the information that is newly generated.

Furthermore, in a case where, at Step S2, the information processing apparatus 1 selects the other company generative AI from among the plurality of pieces of generative AI and determines that the response to the new prompt is not available by using the past generated information, the information processing apparatus 1 inputs the information including the new prompt to the other company generative AI as the input information via the generative AI-API, causes the other company generative AI to generate the response information that indicates the response to the new prompt or the information that is used to generate the response information as the new generated information, and acquires such new generated information via the generative AI-API (Step S4A-2). The information that is used to generate the response information is, for example, the intention information described above. a method for generating the new generated information is the same as the method for generating the past generated information described above.

Then, the information processing apparatus 1 provides, as the response information, the new generated information that has been acquired at Step S4A-2 or the information based on the new generated information to the user U (Step S4A-3). A method for generating information based on the new generated information is the same as the method for generating the information based on the past generated information described above.

Furthermore, in a case where, at Step S2, the information processing apparatus 1 has selected the in-house generative AI from among the plurality of pieces of generative AI, the information processing apparatus 1 inputs the information including the new prompt to the selected in-house generative AI, and causes the in-house generative AI to generate the response information that indicates the response to the new prompt or the information that is used to generate such response information as the new generated information (Step S3B). The information that is used to generate the response information is, for example, the intention information described above. A method for generating the new generated information is the same as the method for generating the past generated information described above, but is not limited to this example.

Then, the information processing apparatus 1 provides the new generated information acquired at Step S3A or the information based on the new generated information as the response information to the user U (Step S4B). a method for generating the information based on the new generated information is the same as the method for generating the information based on the past generated information described above, but is not limited to this example.

Moreover, in a case where, at Step S2, the information processing apparatus 1 has selected the in-house generative AI from among the plurality of pieces of generative AI, the information processing apparatus 1 is also able to determine whether or not the response to the new prompt is available by using the past generated information that is the information generated by using the selected in-house generative AI in the past.

In this case, in a case where the information processing apparatus 1 determines that the response to the new prompt is available by using the past generated information, the information processing apparatus 1 provides the past generated information or the information based on the past generated information as the response information that indicates the response to the new prompt to the user U, and, if not, the information processing apparatus 1 performs the processes at Steps S3B and S4B.

In the example described above, the information processing apparatus 1 receives the query including the new prompt, but is able to receive a query for obtaining a new prompt, instead of or in addition to the query including the new prompt. In this case, the information processing apparatus 1 obtains a new prompt by manipulating or processing the information included in the query for obtaining the new prompt.

For example, the information processing apparatus 1 includes dictionary information in which one or more keywords and prompts are associated with each of one or more keywords. The information processing apparatus 1 extracts one or more keywords from the information that is included in the query for obtaining the new prompt, and obtains the prompts that are associated with one or more extracted keywords as the new prompt.

Furthermore, the information processing apparatus 1 may also include the dictionary information in which both of the vector information and the prompt are associated with the vector information. In this case, the information processing apparatus 1 performs vectorization on the information included in the query for obtaining the new prompt, and is able to obtain, as the new prompt, the prompt that is associated with the vector information in which the degree of similarity with the information that has been subjected to vectorization is the highest or that is associated with the vector information with a value equal to or greater than the threshold. The vector information is the information that has been obtained by performing vectorization on the associated prompt, but may also be the information that has been obtained by performing vectorization on the information that is different from the associated prompt.

Furthermore, in the example described above, the information processing apparatus 1 determines whether or not the response to the new prompt is available by using the past generated information, but the information processing apparatus 1 is also able to determine whether or not the response to the new prompt is available by using the existing information other than the past generated information. The existing information other than the past generated information is, for example, the information other than the information that was generated by using the generative AI in the past, and is, for example, the information that has been generated by AI other than the generative AI, the information that has been generated by a person, or the like.

In this case, the information processing apparatus 1 includes dictionary information in which, for example, the information with a combination of the past prompt and the existing information is included in each of the past prompts, and determines whether or not the response to the new prompt is available by using the existing information other than the past generated information on the basis of the comparison result obtained by comparing the new prompt with the past prompt.

Furthermore, the information processing apparatus 1 is also able to determine whether or not the response to the new prompt is available by using the model that determines whether or not the response to the new prompt is available by using the existing information other than the past generated information and that is obtained by being trained.

Furthermore, the information processing apparatus 1 is also able to calculate the degree of coincidence between the information on the plurality of items of the past prompt and the information on the plurality of items of the new prompt as the score that indicates the comparison result obtained by comparing the past prompt with the new prompt. Furthermore, the information processing apparatus 1 is also able to calculate a degree of difference between the information on the plurality of items of the past prompt and the information on the plurality of items of the new prompt as the score that indicates the comparison result obtained by comparing the past prompt with the new prompt. In this case, in a case where the information processing apparatus 1 satisfies the condition in which the calculated score has been defined in advance (for example, in a case where the degree of coincidence is equal to or greater than the threshold or in a case where the degree of difference is equal to or less than the threshold), the information processing apparatus 1 determines that the response to the new prompt is available.

Furthermore, the information processing apparatus 1 is also able to calculate a value that is obtained by performing weighted addition on both of the degree of coincidence and the degree of difference between the information on the plurality of items of the past prompt and the information on the plurality of items of the new prompt as the score that indicates the comparison result obtained by comparing the past prompt with the new prompt. In this case, the information processing apparatus 1 determines that the response to the new prompt is available in a case where the calculated score is equal to or less than the threshold or is equal to or greater than the threshold.

Furthermore, in the example described above, the information processing apparatus 1 selects the generative AI that is used to generate the response information from among the plurality of pieces of generative AI on the basis of the degree of coincidence between the associated information on the plurality of items and the information on the plurality of items of the new prompt, but is not limited to this example. For example, the information processing apparatus 1 is also able to select the generative AI that is used to generate the response information from among the plurality of pieces of generative AI on the basis of the degree of difference between the associated information on the plurality of items and the information on the plurality of items of the new prompt.

For example, the information processing apparatus 1 is able to select, from among the plurality of pieces of generative AI, the generative AI in which a degree of difference between the associated information on the plurality of items and the information on the plurality of items of the new prompt is the lowest or is equal to or less than the threshold as the generative AI that is used to generate the response information. Furthermore, the information processing apparatus 1 is also able to select the generative AI that is used to generate the response information from among the plurality of pieces of generative AI on the basis of the result of weighted addition performed on the degree of coincidence and the degree of difference.

Furthermore, in the example described above, the information processing apparatus 1 selects the generative AI that is used to generate the response information that indicates the response to the prompt from among the plurality of pieces of generative AI on the basis of the information on the plurality of items included in the prompt, but the example is not limited to this example. For example, the information processing apparatus 1 is also able to select AI other than the generative AI. The AI other than the generative AI may also be a natural language processing model that performs, for example, analysis of a prompt, classification of a prompt, a response to a prompt, or the like, or may also be an AI agent that performs a process in accordance with a prompt. In this case, the information processing apparatus 1 selects the AI that is used to generate the response information that indicates the response to the prompt from among the plurality of pieces of AI on the basis of the information on the plurality of items included in the prompt.

In this way, the information processing apparatus 1 receives a query that includes a new prompt sent from the user U or a query for obtaining the new prompt, determines whether or not a response to the new prompt is available by using the existing information that is already-existing information, and provides, if it is determined that the response to the new prompt is available by using the existing information, the existing information to the user U as the response information indicating the response to the new prompt. As a result of this, the information processing apparatus 1 is able to reduce a processing cost needed when the response information that indicates the response to the prompt is provided.

Furthermore, the information processing apparatus 1 receives a query that includes a prompt sent from the user U or a query for obtaining the prompt, selects AI that is used to generate the response information indicating the response to the prompt from among the plurality of pieces of AI on the basis of the information on the plurality of items included in the prompt, and provides the response information that has been generated by using the selected AI to the user U. As a result of this, the information processing apparatus 1 is able to improve the accuracy of appropriately obtaining the response to the prompt.

In the following, a configuration of an information processing system that includes the information processing apparatus 1 and the plurality of terminal devices 2 that perform the processes described above, and the like will be described in detail.

### [2. Configuration of Information Processing System]

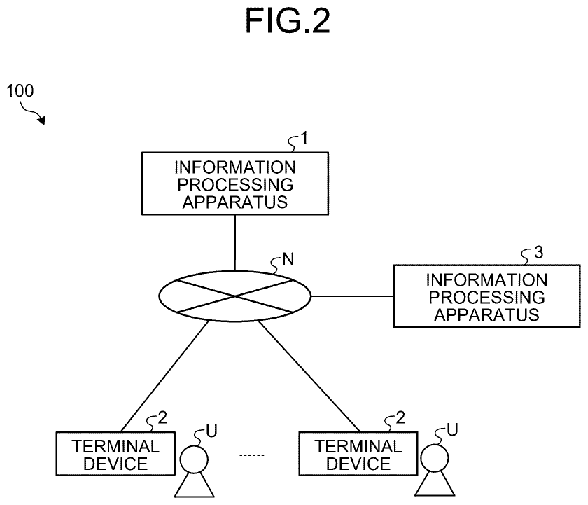

FIG. 2 is a diagram illustrating one example of the configuration of the information processing system according to the embodiment. As illustrated in FIG. 2, an information processing system 100 according to the embodiment includes the information processing apparatus 1, the plurality of terminal devices 2, and the information processing apparatus 3.

The plurality of terminal devices 2 are used by different users U, respectively. Each of the terminal devices 2 is, for example, a notebook personal computer (PC), a desktop PC, a smartphone, a tablet PC, a wearable device. The wearable device is, for example, smart glasses or a smart watch, or the like, but is not limited to these examples.

Each of the information processing apparatus 1, the terminal devices 2, and the information processing apparatus 3 is communicably connected to one another in a wired or wireless manner via a network N. Moreover, the information processing system 100 illustrated in FIG. 2 may also include two or more of the information processing apparatuses 1, two or more of the information processing apparatuses 3, and the like.

The network N includes, for example, a wide area network (WAN), such as the Internet, and mobile telecommunications networks, such as long-term evolution (LTE), 4th generation (4G), and 5th generation (5th generation mobile communication system: 5G).

The terminal devices 2 are connected to the network N via a mobile communication network, near field wireless communication, such as Bluetooth (registered trademark) or a wireless local area network (LAN), and are capable of communicating with the information processing apparatus 1, the information processing apparatus 3, and the like.

### [3. Configuration of Information Processing Apparatus 1]

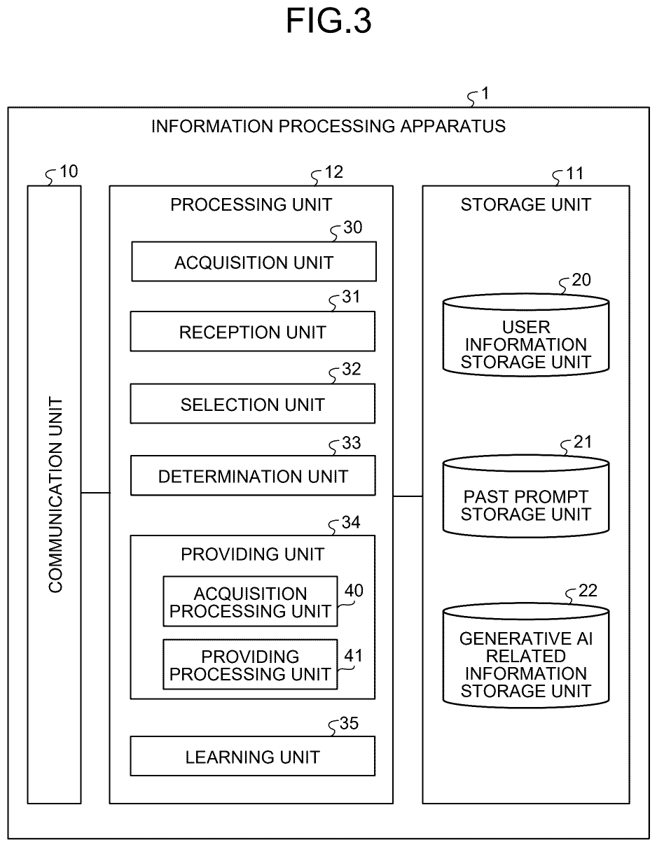

FIG. 3 is a diagram illustrating one example of the configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a network interface card (NIC), or the like. Furthermore, the communication unit 10 is connected to the network N in a wired or wireless manner, and transmits and receives information to and from the other various devices. For example, the communication unit 10 transmits and receives information to and from the terminal device 2 or the information processing apparatus 3 via the network N.

### [3.2. Storage Unit 11]

The storage unit 11 is implemented by, for example, a semiconductor memory device, such as a random-access memory (RAM) or a flash memory, or a storage device, such as a hard disk or an optical disk. The storage unit 11 includes a user information storage unit 20, a past prompt storage unit 21, and a generative AI related information storage unit 22.

### [3.2.1. User Information Storage Unit 20]

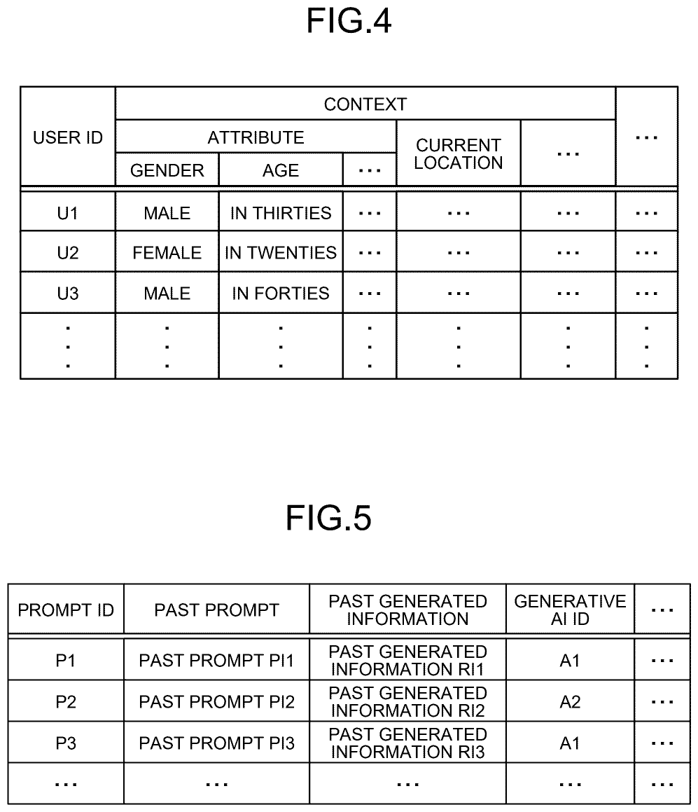

The user information storage unit 20 stores therein user information including the information related to the user U. FIG. 4 is a diagram illustrating one example of a user information table stored in the user information storage unit 20 included in the information processing apparatus 1 according to the embodiment. As illustrated in FIG. 4, the user information table stored in the user information storage unit 20 includes items of “user ID”, “context”, and the like.

The “user ID” is identification information for identifying the user U. The “context” is information that indicates the context of the user U corresponding to the “user ID”. The context of the user U is the current circumstances of the user U, the circumstances surrounding the user U, or the like.

For example, the element of the context of the user U includes an attribute of the user U, the current location of the user U, the current time, a physical environment in which the user U is placed, a social environment in which the user U is placed, a state of motion of the user U, a feeling of the user U, or the like. The attribute of the user U is, for example, a demographic attribute, a psychographic attribute, or the like.

The demographic attribute is an attribute in terms of a demographic characteristic, and includes a plurality of attribute elements of, for example, age, gender, an occupation, a place of residence, an annual income, a family structure, and the like. The psychographic attribute is an attribute in terms of a psychological characteristic, and includes a plurality of attribute elements related to, for example, interests and concerns, a life style, a sense of values, and the like. In a case where that attribute is the demographic attribute, the attribute of the user U is, for example, gender, age (age group), a place of residence, and an occupation, or a combination of two or more of these elements or the like, but is not limited to this example.

The physical environment in which the user U is placed is, for example, temperature, humidity, weather, illuminance, indoor, or outdoor, or a combination of two or more of these elements, but is not limited to this example. The social environment in which the user U is placed is, for example, an economic situation, a political situation, a popular product or service, or a combination of two or more of these elements or the like, but is not limited to this example.

The state of motion of the user U is, for example, a running situation, a walking situation, a sitting situation, or the like, but is not limited to this example. Furthermore, the feeling of the user U is, for example, a smiling situation, an angry situation, a troubling situation, or the like, but is not limited to this example.

Moreover, the context of the user U may be, for example, a combination of two or more of contexts among the attribute of the user U, the current location of the user U, the current time, the physical environment in which the user U is placed, the social environment in which the user U is placed, the state of motion of the user U, and the feeling of the user U.

### [3.2.2. Past Prompt Storage Unit 21]

The past prompt storage unit 21 sores therein various kinds of information related to the past prompt. The past prompt is a prompt that was received by a reception unit 31 in the past and in which generated information has been generated as a result of the generative AI being input.

FIG. 5 is a diagram illustrating one example of a past prompt table stored in the past prompt storage unit 21 included in the information processing apparatus 1 according to the embodiment. In the example illustrated in FIG. 5, the past prompt table stored in the past prompt storage unit 21 includes information on the items of “prompt ID”, a “past prompt”, “past generated information”, a “generative AI ID”, and the like.

The “prompt ID” an identifier for identifying a past prompt, and is information added to each of the past prompts. The “past prompt” is a past prompt corresponding to the “prompt ID”.

The “past generated information” is past generated information obtained such that the information that includes the past prompt corresponding to the “prompt ID” is input to the generative AI and is then output from the generative AI in the past. The past generated information is the past generated information on the in-house generative AI or the past generated information on the other company generative AI.

The “generative AI ID” is an identifier for identifying the generative AI to which the information including the past prompt corresponding to the “prompt ID” has been input, and is information added to each of the pieces of generative AI.

### [3.2.3. Generative AI Related Information Storage Unit 22]

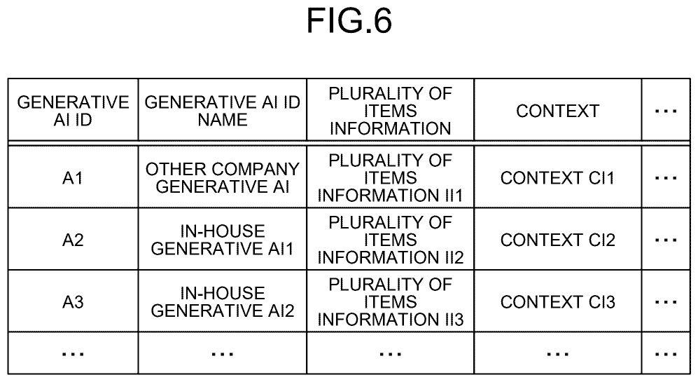

The generative AI related information storage unit 22 stores therein various kinds of information related to each of the plurality of pieces of generative AI. The plurality of pieces of generative AI include a plurality of pieces of the in-house generative AI and a plurality of pieces of the other company generative AI. FIG. 6 is a diagram illustrating one example of a generative AI related information table stored in the generative AI related information storage unit 22 included in the information processing apparatus 1 according to the embodiment.

In the example illustrated in FIG. 6, the generative AI related information table stored in the generative AI related information storage unit 22 includes information on the items of “generative AI ID”, a “generative AI name”, a “plurality of items information”, “context”, and the like. The “generative AI ID” is an identifier for identifying the generative AI, and is information added to each of the pieces of generative AI. The “generative AI name” is information that indicates the name of the generative AI corresponding to the “generative AI ID”.

The generative AI is, for example, text generative AI, image generative AI, or multimodal generative AI. The text generative AI is, for example, a large language model that has been trained to estimate a subsequent token from an input token string and output the estimated token, and is, for example, a transformer based model, a RNN based model, or the like, but may also be a mixed model of these. Furthermore, the text generative AI may also be a complex system constituted in combination with an identification device that is used to prevent unauthorized use.

The transformer based model is, for example, GPT, PaLM2, or the like, but the example is not limited to this example. The RNN based model is, for example, RWKV, or the like, but the example is not limited to this example.

The image generative AI is AI that generates an image from a text, and is, for example, StackGAN, AttnGAN, T2I with Transformers, Diffusion model, or the like, but the example is not limited to this example. Examples of the Diffusion model include DALL-E, Stable-Diffusion, or the like.

The multimodal generative AI is generative AI that generates at least one of a text, an image, and audio from at least one of, for example, the text, the image, and the audio. The multimodal generative AI is, for example, GPT-4 Turbo with vision, gemini, CM3Leon, or the like, but the example is not limited to this example.

Moreover, it is preferable that the above described generative AI is trained such that personal information or the like is not included in the generated result.

The “plurality of items information” is the information on the plurality of items associated with the generative AI corresponding to the “generative AI ID”. Each of the plurality of items is an item that indicates a matter corresponding to a key or a category of a matter corresponding a characteristic, and is an item that indicates a meaning category of, for example, a semantic field, or the like. Furthermore, the information on the item is information that indicates an item (the information that indicates an item itself) or information that indicates the content of the item. The information that indicates the content of the item is the information that indicates the content of the matter corresponding to the key, the information that indicates the content of the matter corresponding to the characteristic, or the like.

The “context” is information that indicates the context associated with the generative AI corresponding to the “generative AI ID”. The context is, for example, information that indicates the context of the user U corresponding to an application target for the generative AI. The context of the user U is the current circumstances of the user U, the circumstances surrounding the user U, or the like.

### [3.3. Processing Unit 12]

The processing unit 12 is a controller, and is implemented by causing a processor, such as a central processing unit (CPU) or a micro processing unit (MPU), to execute various programs (corresponding to one example of an information processing program) stored in a storage device included in the information processing apparatus 1 by using RAM or the like as a work area.

Furthermore, the processing unit 12 is a controller (controller), and may be implemented by, for example, an integrated circuit, such as an application specific integrated circuit (ASIC), a field programmable gate array (FPGA), or a general purpose graphic processing unit (GPGPU).

As illustrated in FIG. 3, the processing unit 12 includes an acquisition unit 30, the reception unit 31, a selection unit 32, a determination unit 33, a providing unit 34, and a learning unit 35, and implements or executes a function or an operation of the information processing that will be described below. Moreover, the internal configuration of the processing unit 12 is not limited to the configuration illustrated in FIG. 3, and may be any other configuration as long as the processing unit 12 is configured to execute information processing that will be described later.

### [3.3.1. Acquisition Unit 30]

The acquisition unit 30 acquires various kinds of information from an external device or the like via the network N and the communication unit 10, or acquires various kinds of information from the storage unit 11.

For example, the acquisition unit 30 acquires information on the user U from the terminal device 2, an information processing apparatus that is provided outside, or the like, and causes the user information storage unit 20 to store the acquired information on the user U. The information on the user U is, for example, the context of the user U.

Furthermore, the acquisition unit 30 acquires various kinds of information from the user information storage unit 20, the past prompt storage unit 21, the generative AI related information storage unit 22, and the like.

### [3.3.2. Reception Unit 31]

The reception unit 31 receives a query that includes a prompt sent from the user U or a query for obtaining a new prompt. For example, the reception unit 31 receives a new prompt that is a prompt that is newly received from the user U.

In a case where the reception unit 31 receives a query for obtaining a new prompt, the reception unit 31 obtains a new prompt by manipulating or processing the information included in the query for obtaining the new prompt. For example, the reception unit 31 includes dictionary information in which one or more keywords and prompts are associated with each of one or more keywords. The reception unit 31 extracts one or more keywords from the information that is included in the query for obtaining the new prompt, and obtains the prompts that are associated with one or more extracted keywords as the new prompt.

Furthermore, the reception unit 31 may also include the dictionary information in which both of the vector information and the prompt are associated with the vector information. In this case, the reception unit 31 performs vectorization on the information included in the query for obtaining the new prompt, and is able to obtain, as the new prompt, the prompt that is associated with the vector information in which the degree of similarity with the information that has been subjected to vectorization is the highest or that is associated with the vector information with a value equal to or greater than the threshold. The vector information is the information that has been obtained by performing vectorization on the associated prompt, but may also be the information that has been obtained by performing vectorization on the information that is different from the associated prompt.

Moreover, the process of obtaining a new prompt by manipulating or processing the information included in the query for obtaining the new prompt is not limited to the process performed by the reception unit 31, and may be a process performed by, for example, an obtaining unit included in the processing unit 12.

The user U is able to input or select the information for obtaining a prompt by operating the terminal device 2, and, as a result of this, a use request including a new prompt or a use request for obtaining the new prompt is transmitted from the terminal device 2 to the information processing apparatus 1. The reception unit 31 receives the new prompt included in the use request by receiving the use request sent from the terminal device 2. The use request including the new prompt or the use request for obtaining the new prompt is one example of a query that includes the prompt described above or a query for obtaining the new prompt.

Furthermore, the reception unit 31 receives the evaluation information that is the information on an evaluation performed, by the user U, on the provided information that has been provided by the providing unit 34. The user U operates the terminal device 2, and is able to input the information that indicates the evaluation performed on the provided information that has been provided by the providing unit 34. As a result of this, the evaluation information that is transmitted from the terminal device 2 to the information processing apparatus 1 is the information that indicates an evaluation value obtained using, for example, an evaluation indicated on a scale of 5, but is not limited to this example.

### [3.3.3. Selection Unit 32]

The selection unit 32 selects the generative AI that is used to generate the response information indicating a response to a new prompt from among the plurality of pieces of generative AI on the basis of the information on the plurality of items included in the new prompt received by the reception unit 31.

The plurality of pieces of generative AI includes both of the in-house generative AI that is the generative AI and that is included in the information processing apparatus 1, and the other company generative AI that is the generative AI and that is included in the information processing apparatus 3. The in-house generative AI is one example of the first generative AI, and the other company generative AI is one example of the second generative AI. The information processing apparatus 3 is one example of another information processing apparatus that is different from the information processing apparatus 1.

Each of the plurality of items is an item that indicates a category of a matter corresponding to a key or a matter corresponding to a characteristic, and is an item that indicates, for example, a meaning category of a semantic field, or the like. Furthermore, the information on the item is the information indicating the content of the matter corresponding to the key, the information indicating the content of the matter corresponding to the characteristic, or the like.

The selection unit 32 extract the information on the plurality of items included in the new prompt by using a technology of slot filtering, or the like. In the slot filtering, each of the items is referred to as a slot, but each of the items is not limited to the slot, but may be any item as long as, as described above, the item indicates the category of the matter corresponding to a key or the matter corresponding to a characteristic.

For example, it is assumed that the new prompt is a prompt that is input to the generative AI in order to generate a piece of advertising content. In this case, the new prompt is information on, for example, a character string indicating that “Please create advertising content of grand opening of an organic coffee shop characterized by a cozy interior. The advertising content should be designed to target the local community.”

In this case, the information on the plurality of items included in the new prompt is the information that indicates the content of the items, such as the information on the character string of “cozy interior”, the information on the character string of “grand opening”, the information on the character string of “organic coffee shop”, and the information on the character string of “local community”. The information on the character string of “cozy interior” is the information indicating the content of the item of “design of an inside of the store”, and the information on the character string of “grand opening” is the information indicating the content of the item of “state of the store”.

Furthermore, the information on the character string of “organic coffee shop” is the information indicating the content of the item of “category of the store”, and the information on the character string of “local community” is the information indicating the content of the item of “place of residence of a target user”. The information on the item of “place of residence of the target user” is one example of the information indicating the attribute of the user U who is a target user.

Furthermore, the information on the plurality of items included in the new prompt may be, instead of or in addition to the information indicating the content of the item, for example, information indicating an item of “location of the store”, information indicating an item of “event”, information indicating an item of “coupon or a discount”, information indicating an item of “product price”, information indicating an item of “age group of the target user”, information indicating an item of “interest held by the target user”, or the like.

Furthermore, the new prompt may be, for example, a prompt that is input to the generative AI such that a result of proofreading is generated as the generated information. In this case, the new prompt is information on, for example, a character string indicating that “You are a professional proofreader. I will detect a misspelling, a fluctuation, and other written errors in an input sentence. The maximum number of detections is 20. Please check each sentence carefully. An output format is as follows: ¥n{written error type} ¥n<correct> {written error before correction} ¥n<error> {written error after correction} ¥n¥n{written error type} is a character string indicating the written error type, {written error before correction} is a character string indicating a written error before correction, and {written error after correction} is a character string indicating after correction.”, or the like. Such a new prompt is, for example, a prompt that is input to the generative AI first time, and is input to the generative AI together with the sentence that is targeted for the proofreading and that is additionally input by the user U after the first prompt. The sentence targeted for the proofreading is also a prompt.

The information on the character string indicating that “You are a professional proofreader.” is the information indicating the content of the item of “role of AI”, the information indicating the content of the character string indicating that “I will detect a misspelling, a fluctuation, and other written errors in an input sentence.” is the information on the item of “detection target”, the information on the character string indicating “The maximum number of detections is 20.” is the information indicating the content of the item of “number of detections”, and the information on the character string indicating that “Please check each sentence carefully.” is the information indicating the content of the item or a “detection procedure”.

Furthermore, the character string indicating “An output format is as follows: ¥n{written error type} ¥n<correct> {written error before correction} ¥n<error> {written error after correction} ¥n¥n{written error type} is a character string indicating the written error type, {written error before correction} is a character string indicating a written error before correction, and {written error after correction} is a character string indicating after correction.” is the information indicating the content of the item of “output format”.

Moreover, the information on the item of “output format” may also be information on a segmented item. For example, the information on the item of “output format” may be the information on the item of “output format-written error type”, the information on the item of “output format-written error content”, the information on the item of “output format-correction content”, or the like, and, furthermore, the information on the item of “output format” may also include the information on the item of “output format-detection reason”, or the like.

Furthermore, the new prompt may also be a prompt that is input to the generative AI such that the information indicating a problem or a reply is generated as the generated information. In this case, the new prompt is the information on, for example, the character string indicating that “You are a professional teacher. Under the following constrained condition, I will provide an education service to a user according to the following procedure. ¥n ###constrained condition ¥n1. responding to needs of each learner: give customized guidance in accordance with the knowledge level, the interest, and the learning style of the learner ¥n2, compliance with principles of education: based on a teaching method including educational accuracy and understanding . . . . ¥n procedure ¥n1. understanding the learning goal of the user: check topics and goal that the user wants to learn about ¥n2. generate customized learning plan: generate individual learning plan based on the needs and the goal of the user . . . ”. This new prompt is a prompt that is input to the generative AI first time in order to communicate with the user U in, for example, a chat format, and is input to the generative AI together with the prompt that is additionally input by the user U.

The information on the character string indicating that “You are a professional teacher.” is the information indicating the content of the item of “role of AI”, the information on the character string indicating that “1. To cope with needs of each learner: . . . ” is the information on the content of the item of “constrained condition-responding to needs”, the information on the character string indicating “2. Compliance with principles of education: . . . ” is the information indicating the content of the item of “constrained condition-principles of education”, . . . , the information on the character string indicating “1. To understanding the learning goal of the user: . . . ” is the information indicating the content of the item of “procedure-understanding the goal”, . . . , and the information on the character string indicating that “2. To generate a customized learning plan: . . . ” is the information indicating the content of the item of “procedure-generating a learning plan, etc.”.

Furthermore, the information on the item may be, for example, the information on the item of “tone of voice”, the information on the item of “prompt format”, or the like. The information indicating the content of the item of “tone of voice” is the information on, for example, a direct command indicating “Do”, or the like, or an indirect command indicating “Please do”, or the like. The information that indicates the content of the item of “prompt format” is information on, for example, zero-shot (Zero-shot), one-shot (One-shot), few-shot (Few-shot), or the like.

The selection unit 32 extracts pieces of information that indicate the plurality of respective items from the new prompt on the bases of, for example, a rule base. For example, the selection unit 32 includes dictionary information including a plurality of terms for each item, and is able to extract the information that is related to the plurality of items from the new prompt by using the dictionary information.

Furthermore, the selection unit 32 includes an extraction model that extracts information a plurality of items included in the new prompt that has been received by the reception unit 31, and is also able to extract the information on the plurality of items included in the new prompt by using the extraction model.

The extraction model is a model that has been trained to extract the information on the plurality of items from the prompt, and is a model that has been trained to extract the information on the plurality of items from the prompt by using the learning purpose information that includes, for each prompt, a combination of a prompt and the information on the plurality of items included in the prompt. The extraction model is, for example, a Long Short-Term Memory (LSTM) or a Transformer based model, but may also be the above described generative AI, or may be any other model.

Furthermore, the selection unit 32 is also able to extract the information on the plurality of items from the new prompt by using a language model, such as the text generative AI. For example, the selection unit 32 is able to cause the text generative AI to extract the information on the plurality of items by inputting, to the text generative AI, both of the instruction information that indicates an instruction to extract the information on the plurality of items from the new prompt and the information that includes the new prompt.

Furthermore, the information on the plurality of items is associated with each of the plurality of pieces of generative AI including the in-house generative AI and the other company generative AI. For example, in the generative AI related information storage unit 22, the information on the plurality of items is associated with the plurality of pieces of generative AI, respectively.

The selection unit 32 selects the generative AI that is used to generate the response information from among the plurality of pieces of generative AI on the basis of the comparison result obtained by comparing the information on the plurality of items associated with the plurality of pieces of generative AI, respectively, with the information on the plurality of items included in the new prompt.

For example, the selection unit 32 selects, from among the plurality of pieces of generative AI, the generative AI having the highest degree of coincidence between the associated information on the plurality of items and the information on the plurality of items included in the new prompt. The degree of coincidence is, for example, the number of the pieces of associated information on the plurality of items and the information on the plurality of items included in the new prompt, a ratio of coincidence, or a value obtained by performing weighted addition on these results, but may also be a value obtained by adding the weight of the coincident items in a case where different weighting is applied to each of the items.

Furthermore, the selection unit 32 is also able to select, from among the plurality of pieces of generative AI, the generative AI in which the degree of coincidence between the associated information on the plurality of items and the information on the plurality of items included in the new prompt is equal to or greater than a threshold. In this case, in a case where a plurality of pieces of generative AI, in which the degree of coincidence between the associated information on the plurality of items and the information on the plurality of items included in the new prompt is equal to or greater than the threshold, is present, the selection unit 32 randomly selects or selects in accordance with the rule that has been defined in advance a single piece of generative AI from among these pieces of generative AI.

Furthermore, the selection unit 32 is also able to select the generative AI that is used to generate the response information from among the plurality of pieces of generative AI on the basis of the context of the user U and the information on the plurality of items included in the new prompt.

For example, the context may be associated with each of the plurality of pieces of generative AI, in addition to the information on the plurality of items. In this case, the selection unit 32 selects the generative AI that is used to generate the response information that indicates the response to the new prompt on the basis of the comparison result between a combination of the information on the plurality of items associated with each of the plurality of pieces of generative AI and the context and a combination of the information on the plurality of items included in the new prompt and the context of the user.

For example, the selection unit 32 selects, from among the plurality of pieces of generative AI, the generative AI having the highest degree of coincidence between a combination of the associated information on the plurality of items and the context and a combination of the information on the plurality of items included in the new prompt and the context of the user U.

In a case where the context includes a plurality of elements, the degree of coincidence of the context is the number of elements that are coincident with each other, the rate of coincident elements, or a value obtained by performing weighted addition on these results, but, in a case where different weighting is applied to each of the elements, the degree of coincidence of the context may also be a value obtained by adding the weight of the coincident elements. The selection unit 32 selects, from among the plurality of pieces of generative AI, the generative AI having the highest value obtained by performing weighted addition on the degree of coincidence of the plurality of items and the degree of coincidence of the context.

Furthermore, the selection unit 32 is able to select the generative AI that is used to generate the response information from among the plurality of pieces of generative AI on the basis of the comparison result between a combination of the information on the plurality of items associated with each of the plurality of pieces of generative AI and the context and a combination of the information on the plurality of items included in the new prompt and the context of the user U.

In this case, the selection unit 32 selects, from among the plurality of pieces of generative AI, the generative AI having the highest degree of coincidence between a combination of the associated information on the plurality of items and the context and a combination of the information on the plurality of items included in the new prompt and the context of the user U. The degree of coincidence is a value obtained by performing weighted addition on, for example, the degree of coincidence between the associated information on the plurality of items the information on the plurality of items of the new prompt and the degree of coincidence between the associated context and the context of the user U.

Furthermore, in a case where a plurality of generative AI, in which the degree of coincidence between a combination of the associated information on the plurality of items and the context and a combination of the information on the plurality of items included in the new prompt and the context of the user U is equal to or greater than the threshold, are present, the selection unit 32 randomly selects or selects in accordance with the rule that has been defined in advance a single piece of generative AI from among these pieces of generative AI.

Furthermore, the selection unit 32 includes the selection model that selects a single piece of generative AI between the in-house generative AI and the other company generative AI and that has been obtained by being trained, and is also able to select one of the pieces of generative AI between the in-house generative AI and the other company generative AI by using the selection model.

The selection model is generated by the learning unit 35 by using, for example, as the learning purpose information, the information that includes, for each prompt, both of the information on the prompt and the information that indicates an evaluation performed, by the user U, on the provided information that has been generated by using the generative AI on the basis of the information including this prompt and that has been provided to the user U. The selection model is, for example, LSTM or the Transformer based model, but may also be the generative AI described above, or may also be another model.

The selection unit 32 inputs the information on the new prompt to the selection model, and determines whether the in-house generative AI is used or the other company generative AI is used in accordance with whether the value that is output from this selection model is a positive value or a negative value.

Furthermore, the selection unit 32 may also include, as a selection model, a model that determines whether or not a response to the new prompt is available by using the generated information that is generated by using the in-house generative AI and is a model that is obtained by being trained. In this case, the selection unit 32 is also able to determine, by using the selection model, whether or not a response to the new prompt is available by using the generated information that is generated by using the in-house generative AI.

The selection model is a model that has been trained by using the learning purpose information that includes, for each prompt, for example, the prompt that was input to the in-house generative AI in the past and the evaluation information that indicates the evaluation performed, by the user U, on the provided information that has been generated by using that prompt. The evaluation information is the information that indicates the evaluation performed by the user U who provides, as the provided information, the generated information that has been generated by using the in-house generative AI or the information based on that generated information, and is the information that indicates the evaluation value obtained using, for example, an evaluation indicated on a scale of 5.

In this case, in a case where a new prompt or each of the terms included in the new prompt is input to the selection model, if the value output from the selection model is equal to or greater than the threshold, the selection unit 32 determines that a response to the new prompt is available by using the generated information that is generated by using the in-house generative AI.

Furthermore, in the selection unit 32, in a case where a plurality of pieces of in-house generative AI are present, the selection model may be a model that outputs a value (score) for each of the pieces of in-house generative AI in response to an input of the new prompt or each of the terms included in the new prompt. The selection unit 32 is able to select the in-house generative AI that is associated with a value that is output from the selection model and that is equal to or greater than the threshold and a value that is the highest value.

Moreover, in a case where the information that assigns the generative AI is included in the use request, the selection unit 32 is also able to select the generative AI assigned by the use request from among the plurality of pieces of generative AI.

Furthermore, the selection unit 32 is also able to select the generative AI that is used to generate the response information from among the plurality of pieces of generative AI on the basis of a degree of difference between the associated information on the plurality of items and the information on the plurality of items of the new prompt. For example, the selection unit 32 selects, from among the plurality of pieces of generative AI, the generative AI in which a degree of difference between the associated information on the plurality of items and the information on the plurality of items of the new prompt is the lowest or is equal to or less than the threshold as the generative AI that is used to generate the response information.

Furthermore, the selection unit 32 is also able to select AI other than the generative AI. The AI other than the generative AI may also be a natural language processing model that performs, for example, analysis of a prompt, classification of a prompt, a response to a prompt, or the like. In this case, the selection unit 32 selects the AI that is used to generate the response information that indicates the response to the prompt from among the plurality of pieces of AI on the basis of the information on the plurality of items included in the prompt.

### [3.3.4. Determination Unit 33]

The determination unit 33 determines whether or not a response to a new prompt is available by using the past generated information that is the information generated by using the generative AI in the past.

For example, the determination unit 33 determines whether or not the response to the new prompt is available by using the past generated information that is the information generated by using the other company generative AI in the past. In a case where, for example, the other company generative AI has been selected from among the plurality of pieces of generative AI by the selection unit 32, the determination unit 33 determines whether or not a response to the new prompt is available by using the past generated information that is the information that was generated in the past by using the other company generative AI.

For example, the determination unit 33 determines whether or not the response to the new prompt is available by using the past generated information on the basis of the prompt comparison result obtained by comparing the past prompt that is the former prompt that has been used to generate the past generated information and the new prompt. The past prompt that is the former prompt that has been used to generate the past generated information is, for example, the past prompt that is stored in the past prompt storage unit 21.

The determination unit 33 calculates a score that indicates the comparison result obtained by comparing the former prompt that has been used to generate the past generated information with the new prompt, and determines, if the calculated score satisfies a predetermined condition (for example, in a case where the score is equal to or greater than the threshold or is equal to or less than the threshold), that the response to the new prompt is available. The score that indicates the comparison result between the former prompt and the new prompt is indicated by, for example, a degree of similarity or a degree of difference between the vectorized prompts. The prompts are vectorized by, for example, embedding, or the like performed by a sentence embedding model (for example, a transformer based model).

The embedding obtained by using the sentence embedding model is embedding performed by using, for example, text-embedding-ada, BERT, or the like provided by OpenAI company, but is not limited to this example. Moreover, vectorization performed on content is not limited to embedding obtained by using the sentence embedding model, but vectorization on content may be performed by using, for example, Doc2Vec, an average of word embedding, or the like. For word embedding, for example, Word2Vec embedding, fastText, or the like is used.

The determination unit 33 performs vectorization on each of the past prompts, and performs vectorization on a new prompt. Then, the determination unit 33 determines whether or not a past prompt in which a degree of similarity with the new prompt is equal to or greater than a threshold is present, or a past prompt in which a degree of difference with the new prompt is equal to or less than a threshold is present. If the determination unit 33 determines that the past prompt in which the degree of similarity with the new prompt is equal to or greater than the threshold is present or determines that the past prompt in which the degree of difference with the new prompt is equal to or less than the threshold is present, the determination unit 33 determines that the response to the new prompt is available by using the past generated information that is the generated information that was generated in the past by using the past prompt by the other company generative AI.

The degree of similarity between the new prompt and the past prompt is a cosine degree of similarity, but may also be a Jaccard degree of similarity, or the like, or may also be a reciprocal of the Euclidean distance, a reciprocal of the Manhattan distance, or the like. Furthermore, the degree of similarity between the new prompt and the past prompt is, for example, a reciprocal of the degree of similarity between the new prompt and the past prompt.

Furthermore, the determination unit 33 is also able to extract the information on the plurality of items from the past prompt. The determination unit 33 is able to extract the information on the plurality of items from each of the past prompts by using the dictionary information, the extraction model, or the generative AI described above.

The determination unit 33 is also able to determine whether or not the response to the new prompt is available on the basis of the degree of coincidence between the information on the plurality of items included in the past prompt and the information on the plurality of items included in the new prompt. For example, in a case where the determination unit 33 determines that the past prompt in which the degree of coincidence with the information on the plurality of items of the new prompt is equal to or greater than the threshold is present, the determination unit 33 determines that the response to the new prompt is available by using the past generated information that has been generated by using the past prompt by the other company generative AI.

The determination unit 33 is also able to determine whether or not the response to the new prompt is available by using the determination model that determines whether or not the response to the new prompt is available by using the past generated information and that has been obtained by being trained.

The determination model is generated by the learning unit 35 that will be described later, that determines whether or not the response to the new prompt is available by using the past generated information, and that has been obtained by being trained. The determination model is one example of a model that determines whether or not the response to the new prompt is available by using the generated information that is generated by using the other company generative AI that is different from the in-house generative AI.

The determination unit 33 inputs the information on the new prompt to the determination model, and determines that, if the value that is output from the subject determination model is equal to or greater than the threshold, a response to the new prompt is available by using the past generated information.

Furthermore, the determination unit 33 is also able to determine whether or not the response to the new prompt is available by using the past generated information that is the information generated by using the in-house generative AI in the past. In a case where, for example, the in-house generative AI has been selected from among the plurality of pieces of generative AI by the selection unit 32, the determination unit 33 determines whether or not the response to the new prompt is available by using the past generated information that is the information that was generated by using the selected in-house generative AI in the past.

In this case, the determination unit 33 is able to determine whether or not the response to the new prompt is available by using the past generated information that is the information that was generated by using the in-house generative AI in the past by using the same method as the method for determining whether or not the response to the new prompt is available by using the past generated information that is the information that was generated by using the other company generative AI in the past.

Furthermore, the determination unit 33 determines whether or not the response to the new prompt is available by using the past generated information, but is also able to determine whether or not the response to the new prompt is available by using the existing information other than the past generated information. The existing information other than the past generated information is, for example, the information other than the information that was generated by using the generative AI in the past, and is, for example, the information generated by the AI that is other than the generative AI, the information created by a person, or the like.

For example, the determination unit 33 includes dictionary information in which, for example, the information with a combination of the past prompt and the existing information is included in each of the past prompts, and determines whether or not the response to the new prompt is available by using the existing information other than the past generated information on the basis of the comparison result obtained by comparing the new prompt with the past prompt.

Furthermore, the determination unit 33 is also able to determine whether or not the response to the new prompt is available by using the model that determines whether or not the response to the new prompt is available by using the existing information other than the past generated information and that is obtained by being trained.

Furthermore, the determination unit 33 is also able to calculate the degree of coincidence between the information on the plurality of items of the past prompt and the information on the plurality of items of the new prompt as the score that indicates the comparison result obtained by comparing the past prompt with the new prompt. Furthermore, the determination unit 33 is also able to calculate a degree of difference between the information on the plurality of items of the past prompt and the information on the plurality of items of the new prompt as the score that indicates the comparison result obtained by comparing the past prompt with the new prompt. In this case, in a case where the information processing apparatus 1 satisfies the condition in which the calculated score has been defined in advance (for example, in a case where the degree of coincidence is equal to or greater than the threshold or in a case where the degree of difference is equal to or less than the threshold), the determination unit 33 determines that the response to the new prompt is available.

Furthermore, the determination unit 33 is also able to calculate a value that is obtained by performing weighted addition on both of the degree of coincidence and the degree of difference between the information on the plurality of items of the past prompt and the information on the plurality of items of the new prompt as the score that indicates the comparison result obtained by comparing the past prompt with the new prompt. In this case, the determination unit 33 determines that the response to the new prompt is available in a case where the calculated score is equal to or less than the threshold or is equal to or greater than the threshold.

### [3.3.5. Providing Unit 34]

The providing unit 34 provides various kinds of information. For example, the providing unit 34 provides the various kinds of information to the user U by transmitting the various kinds of information to the terminal device 2 via the communication unit 10 and the network N. The providing unit 34 provides, for example, the response information that has been generated by using the AI selected by the selection unit 32 to the user U.

For example, the providing unit 34 provides the response information generated by the generative AI that has been selected by the selection unit 32 to the user U. For example, in a case where it is determined by the determination unit 33 that the response to the new prompt is available by using the past generated information, the providing unit 34 provides the past generated information or the information based on the past generated information to the user U as the response information indicating the response to the new prompt. Moreover, the information based on the past generated information is the information that was generated in the past, but may also be the information that has been newly generated on the basis of the past generated information. The information based on the generated information is the information that is generated on the basis of the generated information by the providing unit 34.

For example, if it is determined that the response to the new prompt is available by using the past generated information, the providing unit 34 decides the decides the past generated information that is associated with the above described past prompt having the highest degree of similarity or the highest degree of coincidence with the new prompt.

The past generated information is the former generated information obtained such that the information including the target prompt is input to the generative AI as the input information and is then output from the other company generative AI. The target prompt is, for example, the past prompt in which a degree of similarity of the vector with the new prompt is equal to or greater than the threshold or the past prompt in which a degree of coincidence with the information on the plurality of items is equal to or greater than the threshold. In a case where a plurality of past prompts in which the degree of similarity or the degree of coincidence is equal to or greater than the threshold are present, the target prompt is the past prompt having the highest degree of similarity or the highest degree of coincidence, or is the past prompt that has been randomly selected or selected in accordance with the rule that has been defined in advance from among the plurality of past prompts in which the degree of similarity or the degree of coincidence is equal to or greater than the threshold.

Moreover, the target prompt may be the past prompt in which the score obtained by performing weighted addition on the degree of similarity and the degree of coincidence is equal to or greater than the threshold. In this case, the determination unit 33 described above is also able to determine that the response to the new prompt is available by using the past generated information, in a case where the past prompt in which the score is equal to or greater than the threshold is present.

In a case where it is determined by the determination unit 33 that the response to the new prompt is available by using the past generated information that has been generated by the other company generative AI, the past generated information associated with the past prompt is the information generated by the other company generative AI when the information including the past prompt was input to the other company generative AI in the past,

Furthermore, in a case where the it is determined by the determination unit 33 that the response to the new prompt is available by using the past generated information that has been generated by the in-house generative AI, the past generated information associated with the past prompt is the information generated by the in-house generative AI when the information including the past prompt was input to the in-house generative AI in the past.

The past generated information is the information that is output from the generative AI in a case where the information including a prompt received from the user U is input to the generative AI, but, in a case where the prompt received from the user U is a scenario, or the like, the past generated information may be the information that is output from the generative AI as a result of a dialogue history that includes both of the prompt and the history of the information that is output from the generative AI being repeatedly input to the generative AI.

The scenario includes some of or all of the information on the character string that indicates, for example, a definition of a task performed by the generative AI, a constrained condition of the task in the generative AI, a definition of a behavior or a tone of the generative AI, an output format of the generative AI, or the like, but is not limited to the example.

The information based on the past generated information is the pieces of information collected by the providing unit 34 or the information processing apparatus 3 on the basis of the information indicating the intention category and the information indicating the intention content, in a case where, for example, the past generated information is the intention information that includes both of the information indicating the intention category and the information including the intention content.

The intention category is, for example, a category of an intention of the additional information, and the information indicating the intention category is the information for specifying, for example, a mathematical function or a function according to the intention category. Furthermore, the intention content is the content of the intention of the additional information, and the information indicating the intention content is the information indicating, for example, an argument of the mathematical function or a parameter for the function according to the intention category.

The generative AI is able to output the intention information in a case where the information that includes intention definition information for extracting both of the intention category and the intention content is input to the input information, in addition to the prompt input from the user U. The providing unit 34 is able to cause the generative AI to generate the intention information by using a function of function calling, in a case where the generative AI-API is an API provided by OpenAI company.

Furthermore, the past generated information may be the information that is output from the generative AI by inputting, to the generative AI, the information that includes both of the both of the collection information that is the information collected as described above and the instruction information for instructing a process to be performed on such collection information.

The providing unit 34 includes an acquisition processing unit 40 and a providing processing unit 41. The acquisition processing unit 40 acquires past generated information on the other company generative AI from the past prompt storage unit 21, or the like, in a case where it is determined by the determination unit 33 that the response to the new prompt is available by using the past generated information on the other company generative AI.

Furthermore, in a case where it is determined that the response to the new prompt is not available by the determination unit 33 by using the past generated information on the other company generative AI, the acquisition processing unit 40 inputs the information including the new prompt as the input information to the other company generative AI via the generative AI-API, causes the other company generative AI to generate, as the new generated information, the response information indicating the response to the new prompt or information for generating the response information, and acquires the generated information via the generative AI-API.

Furthermore, in a case where the in-house generative AI has been selected from among the plurality of pieces of generative AI by the selection unit 32, the providing unit 34 inputs the information including the new prompt to the in-house generative AI that has been selected by the selection unit 32, causes the in-house generative AI to generate the response information indicating the response to the new prompt or the information for generating the response information as the new generated information, and acquires the generated information.

Furthermore, in a case where it is determined by the determination unit 33 that the response to the new prompt is available by using the past generated information on the in-house generative AI, the acquisition processing unit 40 acquires the past generated information on the in-house generative AI from the past prompt storage unit 21, or the like.

Furthermore, in a case where it is determined, by the determination unit 33, the response to the new prompt is not available by using the past generated information on the in-house generative AI, the acquisition processing unit 40 inputs the information including the new prompt to the in-house generative AI as the input information, and acquires the response information indicating the response to the new prompt or the information for generating the response information as the new generated information from the in-house generative AI.

The providing processing unit 41 provides the new generated information acquired by the acquisition processing unit 40 or the information based on the new generated information to the user U as the response information. For example, the providing processing unit 41 provides the response information to the user U by transmitting the new generated information acquired by the acquisition processing unit 40 or the information based on the new generated information as the response information to the terminal device 2.

For example, in a case where the new generated information is the intention information that includes both of the information indicating the intention category and the information indicating the intention content, the providing processing unit 41 collects the information corresponding to the new generated information from the information processing apparatus 1 or the information processing apparatus 3 on the basis of the information indicating the intention category and the information indicating the intention content.

The intention category is, for example, the category of the intention of the additional information, and the information indicating the intention category is, for example, the information for specifying the mathematical function according to the intention category or the function. Furthermore, the intention content is the content of the intention of the additional information, and the information indicating the intention content is the information indicating, for example, the argument of the mathematical function or the parameter for the function according to the intention category.

Furthermore, the new generated information or the information based on the new generated information may be the information that is output from the generative AI by inputting the collection information that is the information that includes both of the information collected as described above and instruction information for instructing the process to be performed on the collection information to the generative AI.

### [3.3.6. Learning Unit 35]

The learning unit 35 generates various kinds of models by machine learning. For example, the learning unit 35 generates a plurality of models that includes the extraction model, the selection model, and the determination model, or the like described above.

For example, the learning unit 35 generates an extraction model by using the learning purpose information that includes, for each prompt, a combination of the prompt and the information on the plurality of items included in the prompt. The extraction model is a model that has been trained to extract the information on the plurality of items from the information on the prompt. The extraction model is, for example, LSTM or the Transformer based model, but may also be the generative AI described above, or may also be another model. For example, the extraction model may also be a neural network, a gradient boosting decision tree (GBDT), or the like.

Furthermore, the learning unit 35 generates the selection model by using, as the learning purpose information, the information that includes, for each prompt, both of the information on the prompt and the information that indicates an evaluation performed, by the user U, on the provided information that has been generated by using the generative AI on the basis of the information including this prompt and that has been provided to the user U.

The selection model is a model for determining whether the in-house generative AI is to be used or the other company generative AI is to be used on the basis of the information on the prompt. The selection model is, for example, LSTM or the Transformer based model, but may also be the generative AI described above, or may also be another model. For example, the extraction model may also be, a neural network, a gradient boosting decision tree (GBDT), or the like. For example, selection model may also be a neural network, a gradient boosting decision tree, or the like.

The selection unit 32 inputs the information on the new prompt to the selection model, and determines whether the in-house generative AI is used or the other company generative AI is used in accordance with whether the value that is output from this selection model is a positive value or a negative value.

In this case, the information on the prompt is the prompt or a plurality of terms included in the prompt. The information that indicates the evaluation is an evaluation value obtained using, for example, an evaluation indicated on a scale of 5. The information that indicates the evaluation is used to generate the selection model by multiplying +1 by one of the evaluation value obtained when the in-house generative AI is used and the evaluation value obtained when the other company generative AI is used, and by multiplying −1 by the other of the evaluation values, for example. The provided information is the generated information that was generated using the generative AI in the past or is the information based on this generated information.

Furthermore, the selection model may also be a model for selecting a single piece of generative AI from among three or more pieces of generative AI that includes one or more pieces of the other company generative AI and two or more pieces of the in-house generative AI. In this case, the learning unit 35 generates the selection model by using, as the learning purpose information, the information that includes, for each prompt, both of the information on the prompt and the information that indicates an evaluation performed, by the user U, on the provided information that has been generated by using the generative AI on the basis of the information including this prompt and that has been provided to the user U.

The learning purpose information includes, for example, as the information indicating the evaluation, the generated information generated by using the other company generative AI or the information indicating an evaluation with respect to the generated information generated by using the other company generative AI and the generated information generated by using the in-house generative AI or the information indicating an evaluation with respect to the generated information generated by using the in-house generative AI.

The selection unit 32 inputs the information on the prompt to the selection model, and selects the generative AI having the highest score that is output from the selection model for each generative AI from among the plurality of pieces of generative AI.

Furthermore, the learning unit 35 generates the determination model by using, as the learning purpose information, the information that includes, for each prompt, both of the information on the prompt and the information that indicates an evaluation performed, by the user U, on the provided information that has been generated by using the other generative AI on the basis of the information including this prompt and that has been provided to the user U.

In this case, the information on the prompt is a prompt or the plurality of terms that are included in the prompt. The information indicating the evaluation is an evaluation value obtained by using, for example, an evaluation indicated on a scale of 5. The provided information is past generated information that has been generated by using the other company generative AI or is the information based on the past generated information.

The determination unit 33 is also able to determine whether or not a response to a new prompt is available by using the determination model. The determination model is, for example, LSTM or the Transformer based model, but may also be the generative AI described above, or may also be another mode. For example, the determination model may also be a neural network, a gradient boosting decision tree, or the like.

The determination unit 33 inputs, for example, the information on the prompt to the determination model, and determines that the response to the prompt is available by using the past generated information, in a case where the value output from the determination model is equal to or greater than the threshold.

### [4. Processing Procedure]

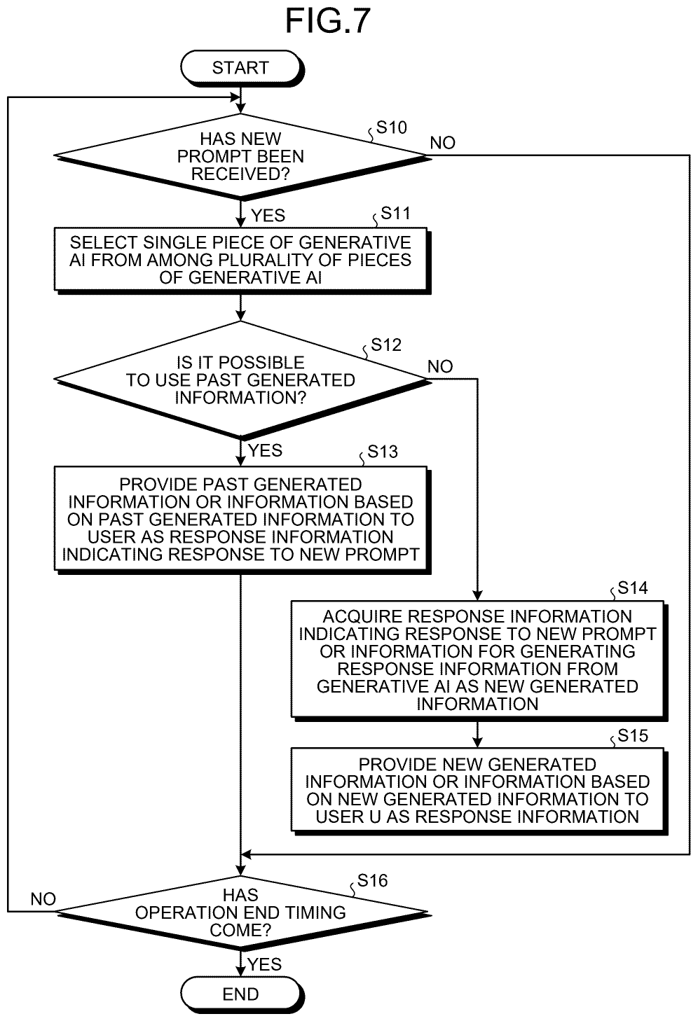

In the following, the process of the information processing performed by the processing unit 12 included in the information processing apparatus 1 according to the embodiment will be described. FIG. 7 is a flowchart illustrating one example of the information processing performed by the processing unit 12 included in the information processing apparatus 1 according to the embodiment.

As illustrated in FIG. 7, the processing unit 12 included in the information processing apparatus 1 determines whether or not a new prompt sent from the user U has been received (Step S10). If the processing unit 12 determines that a new prompt has been received (Yes at Step S10), the processing unit 12 selects a single piece of generative AI from among the plurality of pieces of generative AI (Step S11).

Subsequently, the processing unit 12 determines whether or not a response to the new prompt is available by using the past generated information (Step S12). If the processing unit 12 determines that a response to the new prompt is available by using the past generated information (Yes at Step S12), the processing unit 12 provides the past generated information or the information based on the past generated information to the user U as the response information indicating the response to the new prompt (Step S13).

Furthermore, if the processing unit 12 determines that a response to the new prompt is not available by using the past generated information (No at Step S12), the processing unit 12 acquires the response information indicating the response to the new prompt or the information for generating the response information from the generative AI as the new generated information (Step S14). Then, the processing unit 12 provides the new generated information or the information based on the new generated information to the user U as the response information (Step S15).

If the processing unit 12 has ended the process at Step S13, if the processing unit 12 has ended the process at Step S15, or if the processing unit 12 determines that a new prompt has not been received (No at Step S10), the processing unit 12 determines whether or not an operation end timing has come (Step S16). The processing unit 12 determines that the operation end timing has come in a case where, for example, a power supply of the information processing apparatus 1 has been turned off.

If the processing unit 12 determines that an operation end timing has not yet come (No at Step S16), the processing unit 12 proceeds to Step S10, whereas, if the processing unit 12 determines that the operation end timing has come (Yes at Step S16), the processing unit 12 ends the process illustrated in FIG. 7.

### [5. Modification]

In the example described above, the evaluation performed on the provided information by the user U is an evaluation indicated on a scale of 5, but may also be an evaluation indicated on a scale of 4 or less, or an evaluation indicated on a scale of 6 or above. Furthermore, the information indicating an evaluation performed on the provided information by the user U may also be, for example, the number of posts or reposts to X (formerly Twitter), or the like, or may also be an evaluation value calculated from the reviews of the user U, or the like.

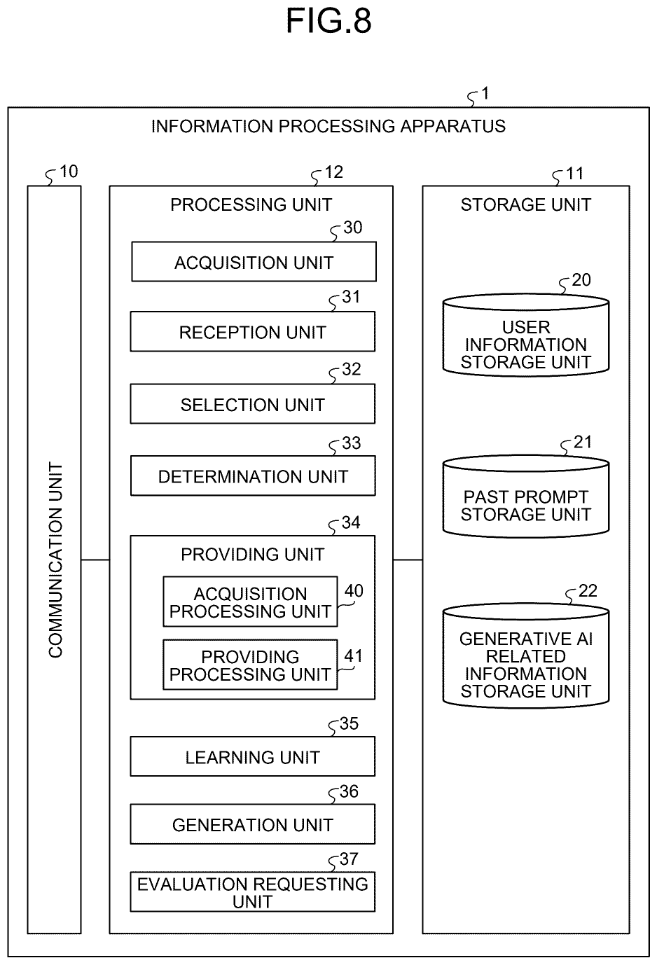

The processing unit 12 may also include a generation unit, an evaluation requesting unit, and the like, in addition to the acquisition unit 30, the reception unit 31, the selection unit 32, the determination unit 33, the providing unit 34, and the learning unit 35. FIG. 8 is a diagram illustrating another example of the configuration of the information processing apparatus 1 according to the embodiment. The information processing apparatus 1 illustrated in FIG. 8 includes a generation unit 36, an evaluation requesting unit 37, and the like, in addition to the acquisition unit 30, the reception unit 31, the selection unit 32, the determination unit 33, the providing unit 34, and the learning unit 35.

The reception unit 31 receives a reference prompt that acts as the basis of a prompt. The generation unit 36 generates a plurality of similar prompts that are a plurality of prompts having content similar to that of the reference prompt that has been received by the reception unit 31. The acquisition unit 30 acquires both of the reference prompt received by the reception unit 31 and the plurality of similar prompts generated by the generation unit 36.

The providing unit 34 provides the reference generated information that is the information generated by using the generative AI on the basis of the information that includes the reference prompt to the user U. Furthermore, the providing unit 34 provides the similar generated information that is the information generated, for each similar prompt, by using the generative AI on the basis of the information that includes the corresponding similar prompt corresponding from among the plurality of similar prompts to the user U. The reference generated information and the similar generated information are provided to the user U by transmitting the reference generated information and the similar generated information to the terminal device 2 that is used by the user U.

The reception unit 31 receives the reference evaluation information indicating the evaluation with respect to the reference generated information that is the information that has been generated by using the generative AI on the basis of the information including the reference prompt, and also receives the similar evaluation information indicating the evaluation with respect to the similar generated information that is the information that has been generated, for each similar prompt, by using the generative AI on the basis of the information including the corresponding similar prompt from among the plurality of similar prompts.

The learning unit 35 causes the determination model to train the relationship between the content of a change in the similar prompt with respect to the reference prompt and the evaluation with respect to the change on the basis of a change in a difference between the reference prompt and the similar prompt and a change in a difference between the reference evaluation information and the similar evaluation information. The determination model is, for example, a Long Short-Term Memory (LSTM) or a Transformer based model, but may also be the above described generative AI, or may be any other model.

Furthermore, the generation unit 36 generates the plurality of similar prompts by replacing one or more terms included in the reference prompt with similar words or different words having the same meaning. The generation unit 36 includes, for example, a similar word dictionary or a thesaurus dictionary, and generates the plurality of similar prompts by using these dictionaries.

Furthermore, the generation unit 36 generates the plurality of similar prompts by replacing the ending of the words or one or more sentences included in the reference prompt with the ending of the words having different expressions. The generation unit 36 includes the ending of a word a dictionary containing the ending of a word including terms indicating, for example, a plurality of categories of the ending of the word, and generates the plurality of similar prompts by using this dictionary.

Furthermore, the generation unit 36 generates the plurality of similar prompts by adding a specific sentence to the reference prompt. The generation unit 36 generates the plurality of similar prompts by adding the specific sentence to the reference prompt by using the generative AI that has been trained to, for example, add the specific sentence.

Furthermore, the learning unit 35 generates the determination model such that the determination model outputs the similar prompt having a high evaluation in a case where the information including the reference prompt is input to the generative AI. The determination model is, for example, LSTM, a neural network, or a Transformer based model, but may also be the generative AI described above, or may be any other model.

Furthermore, the learning unit 35 generates the determination model for each category of the reference prompt. The category is, for example, a question, an instruction, an opinion (intention), or the like, but is not limited to this example, and may also be a category of, for example, politics, economics, international, technology, science, sport, entertainment, health, society, or the like.

Furthermore, the learning unit 35 is also able to generate the determination model on the basis of a difference between the reference prompt and the similar prompt, a difference between the reference evaluation information and the similar evaluation information, and a difference between the number of tokens of the reference prompt and the number of tokens of the similar prompt.

Furthermore, the evaluation requesting unit 37 transmits an evaluation request including the reference generated information and the similar generated information to the terminal device (for example, the terminal device 2) operated by each of the evaluator (for example, the user U). The reception unit 31 receives the reference evaluation information and the similar evaluation information transmitted from the terminal device 2 operated by each of the user U. The evaluator is each of the user located at the destination of cloud sourcing, or each of predetermined evaluator.

Furthermore, the learning unit 35 causes the model to be trained for each combination of the attribute items of the evaluators. The attribute of the evaluator is, for example, the demographic attribute or the psychographic attribute of the evaluator.

Furthermore, in a case where the learning unit 35 is able to suppress a decrease in output accuracy of the model by a combination of attribute items, the number of which has been reduced from among the plurality of attribute items, within a predetermined range, the learning unit 35 causes the model to be trained for each combination of the attribute items that do not include some of attribute items as the combination of the attribute items of the evaluators. The model is, for example, LSTM, a neural network, or a Transformer based model, but may also be the generative AI described above, or may be any other model.

Furthermore, the learning unit 35 generates the model that is trained to detect, for each category of the reference prompt, the item that has been changed by the similar prompt from among the pieces of information on the plurality of items included in the reference prompt and that is estimated to have a higher similar prompt than the reference prompt. The model is, for example, LSTM, a neural network, or a Transformer based model, but may also be the generative AI described above, or may be any other model.

### [6. Hardware Configuration]

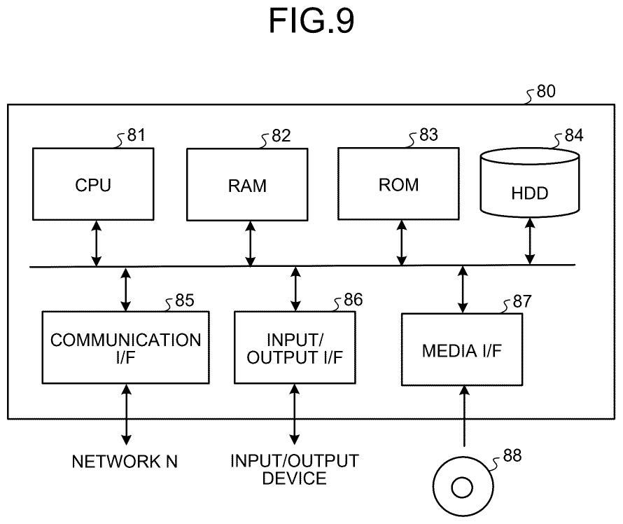

The information processing apparatus 1 according to the embodiment described above is implemented by a computer 80 having a configuration illustrated in, for example FIG. 9. FIG. 9 is a diagram of a hardware configuration illustrating one example of the computer 80 that implements a function of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84, and performs control of each of the units. The ROM 83 stores therein a boot program executed by the CPU 81 at the time of the startup of the computer 80, a program dependent on the hardware of the computer 80, and the like.

The HDD 84 stores therein a program executed by the CPU 81, data that is used by the program, and the like. The communication interface 85 receives data from another device via the network N (see FIG. 2), sends the data to the CPU 81, and transmits the data generated by the CPU 81 to the other devices via the network N.

The CPU 81 controls, via the input/output interface 86, output devices, such as a display and a printer, and input devices, such as a keyboard and a mouse. The CPU 81 acquires data from the input device via the input/output interface 86. Furthermore, the CPU 81 outputs the generated data to the output device via the input/output interface 86.

The media interface 87 reads a program or data stored in a recording medium 88, and provides the program or the data to the CPU 81 via the RAM 82. The CPU 81 loads the program into the RAM 82 from the recording medium 88 via the media interface 87, and executes the loaded program. The recording medium 88 is, for example, an optical recording medium, such as a digital versatile disc (DVD) or a phase change rewritable disk (PD); a magneto optical recording medium, such as a magneto-optical disk (MO); a tape medium; a magnetic recording medium; a semiconductor memory; or the like.

For example, in a case where the computer 80 functions as the information processing apparatus 1 according to the embodiment, the CPU 81 included in the computer 80 implements the function of the processing unit 12 by executing the program loaded into the RAM 82. Furthermore, the HDD 84 stores therein data stored in the storage unit 11. The CPU 81 included in the computer 80 reads and executes the programs from the recording medium 88, but, as another example, the CPU 81 may also acquire the programs from the other device via the network N.

### [7. Others]

Of the processes described in the embodiment, all or a part of the processes that are mentioned as being automatically performed may also be manually performed, or, alternatively, the all or a part of the processes that are mentioned as being manually performed may also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

Furthermore, the components of each unit illustrated in the drawings are only for conceptually illustrating the functions thereof and are not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

For example, the information processing apparatus 1 described above may be implemented by a terminal device and a server computer, or may be implemented by a plurality of server computers, or, alternatively, the configuration may be flexibly changed by calling an external platform or the like by using an API, network computing, or the like depending on the function.

Furthermore, the processes described in the embodiment may appropriately be combined as long as the processes do not conflict with each other.

### [8. Effects]

As described above, the information processing apparatus 1 according to the embodiment includes the reception unit 31, the selection unit 32, and the providing unit 34. The reception unit 31 receives a query including a prompt sent from the user U or a query for obtaining the prompt. The selection unit 32 selects generative AI that is used to generate response information indicating a response to the prompt from among a plurality of pieces of generative AI on the basis of the information on the plurality of items included in the prompt. The providing unit 34 provides the response information that has been generated by using the generative AI selected by the selection unit 32 to the user U. As a result of this, the information processing apparatus 1 is able to enhance the accuracy for appropriately obtaining the response to the prompt.

Furthermore, a plurality of pieces of AI include the plurality of pieces of generative AI. As a result of this, the information processing apparatus 1 is able to enhance the accuracy for appropriately obtaining the response that is given to the prompt and that has been generated by using the generative AI.

Furthermore, the selection unit 32 selects the generative AI that is used to generate the response information from among the plurality of pieces of generative AI on the basis of a comparison result between information on the plurality of items associated with the plurality of respective pieces of generative AI and the information on the plurality of items included in the prompt. As a result of this, the information processing apparatus 1 is able to enhance the accuracy for appropriately obtaining the response to the prompt.

Furthermore, the selection unit 32 selects the generative AI that is used to generate the response information from among the plurality of pieces of generative AI on the basis of the context of the user U and the information on the plurality of items included in the prompt. As a result of this, the information processing apparatus 1 is able to enhance the accuracy for appropriately obtaining the response to the prompt.

Furthermore, the selection unit 32 selects the generative AI that is used to generate the response information from among the plurality of pieces of generative AI on the basis of a comparison result between a combination of the information on the plurality of items associated with the plurality of respective pieces of generative AI and the context and a combination of the information on the plurality of items included in the prompt and the context of the user U. As a result of this, the information processing apparatus 1 is able to enhance the accuracy for appropriately obtaining the response to the prompt.

Furthermore, the selection unit 32 includes the extraction model that extracts the information on the plurality of items included in the prompt received by the reception unit 31, and extracts the information on the plurality of items included in the prompt by using the extraction model. As a result of this, the information processing apparatus 1 is able to enhance the accuracy for appropriately obtaining the response to the prompt.

Furthermore, the plurality of pieces of generative AI includes the first generative AI that is the in-house generative AI included in the information processing apparatus 1, and the second generative AI that is the other company generative AI included in the information processing apparatus 3 that is different from the information processing apparatus 1. The information processing apparatus 3 is one example of the other information processing apparatus. As a result of this, the information processing apparatus 1 is able to enhance the accuracy for appropriately obtaining the response to the prompt.

Furthermore, the information processing apparatus 1 includes the determination unit 33 and the providing unit 34. The determination unit 33 determines, when the second generative AI has been selected by the selection unit 32 as the generative AI that is used to generate the response information, whether or not the response to the prompt is available by using the past generated information that is the information generated by using the second generative AI in the past. The providing unit 34 provides, when it is determined by the determination unit 33 that the response to the prompt is available by using the past generated information, the past generated information or the information based on the past generated information to the user U as the response information indicating the response to the prompt. As a result of this, the information processing apparatus 1 is able to reduce the processing cost needed when the response information indicating the response to the prompt is provided.

Furthermore, the providing unit 34 includes the acquisition processing unit 40 and the providing processing unit 41. The acquisition processing unit 40 inputs, when it is determined by the determination unit 33 that the response to the prompt is not available by using the past generated information, the information including the prompt to the second generative AI as the input information, and acquires the response information indicating the response to the prompt or the information for generating the response information from the second generative AI as the new generated information. The providing processing unit 41 provides the new generated information acquired by the acquisition processing unit 40 or the information based on the new generated information to the user U as the response information. As a result of this, the information processing apparatus 1 is able to enhance the accuracy for appropriately obtaining the response to the prompt.

Furthermore, the information processing apparatus 1 includes the determination unit 33 and the providing unit 34. The determination unit 33 determines, when a single piece of generative AI has been selected from among the plurality of pieces of generative AI by the selection unit 32 as the generative AI that is used to generate the response information, whether or not the response to the prompt is available by using the past generated information that is the information generated by using the single piece of generative AI in the past. The providing unit 34 provides, when it is determined by the determination unit 33 that the response to the prompt is available by using the past generated information, the past generated information or the information based on the past generated information to the user U as the response information indicating the response to the prompt. As a result of this, the information processing apparatus 1 is able to reduce the processing cost needed when the response information indicating the response to the prompt is provided.

Furthermore, the providing unit 34 includes the acquisition processing unit 40 and the providing processing unit 41. The acquisition processing unit 40 inputs, when it is determined by the determination unit 33 that the response to the prompt is not available by using the past generated information, the information including the prompt to the single piece of generative AI as the input information, and acquires the response information indicating the response to the prompt or the information for generating the response information from the single piece of generative AI as the new generated information. The providing processing unit 41 provides the new generated information acquired by the acquisition processing unit 40 or the information based on the new generated information to the user U as the response information. As a result of this, the information processing apparatus 1 is able to enhance the accuracy for appropriately obtaining the response to the prompt.

In the above, embodiments of the present application have been described in detail based on the drawings, but the embodiments are described only by way of an example. In addition to the embodiments described in disclosure of invention, the present invention can be implemented in a mode in which various modifications and changes are made in accordance with the knowledge of those skilled in the art.

Furthermore, the “components (sections, modules, units)” described above can be read as “means”, “circuits”, or the like. For example, the acquisition unit may be read as an acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a reception unit that receives a query including a prompt sent from a user or a query for obtaining the prompt;
a selection unit that selects, based on information on a plurality of items included in the prompt, AI that is used to generate response information indicating a response to the prompt from among a plurality of pieces of AI; and
a providing unit that provides the response information that has been generated by using the AI selected by the selection unit to the user.

2. The information processing apparatus according to claim 1, wherein the plurality of pieces of AI include a plurality of pieces of generative AI.

3. The information processing apparatus according to claim 2, wherein the selection unit selects the generative AI that is used to generate the response information from among the plurality of pieces of generative AI based on a comparison result between information on the plurality of items associated with the plurality of respective pieces of generative AI and the information on the plurality of items included in the prompt.

4. The information processing apparatus according to claim 2, wherein the selection unit selects the generative AI that is used to generate the response information from among the plurality of pieces of generative AI based on a context of the user and the information on the plurality of items included in the prompt.

5. The information processing apparatus according to claim 4, wherein the selection unit selects the generative AI that is used to generate the response information from among the plurality of pieces of generative AI based on a comparison result between a combination of information on the plurality of items associated with the plurality of respective pieces of generative AI and the context and a combination of the information on the plurality of items included in the prompt and the context of the user.

6. The information processing apparatus according to claim 1, wherein the selection unit includes an extraction model that extracts the information on the plurality of items included in the prompt received by the reception unit, and extracts the information on the plurality of items included in the prompt by using the extraction model.

7. The information processing apparatus according to claim 2, wherein the plurality of pieces of generative AI includes
first generative AI that is the generative AI included in the information processing apparatus, and
second generative AI that is generative AI included in another information processing apparatus that is different from the information processing apparatus.

8. The information processing apparatus according to claim 7, further comprising:
a determination unit that determines, when the second generative AI has been selected by the selection unit as the generative AI that is used to generate the response information, whether or not the response to the prompt is available by using past generated information that is information generated by using the second generative AI in the past, and
a providing unit that provides, when it is determined by the determination unit that the response to the prompt is available by using the past generated information, the past generated information or information based on the past generated information to the user as the response information indicating the response to the prompt.

9. The information processing apparatus according to claim 8, wherein the providing unit includes
an acquisition processing unit that inputs, when it is determined by the determination unit that the response to the prompt is not available by using the past generated information, information including the prompt to the second generative AI as input information, and that acquires the response information indicating the response to the prompt or information for generating the response information from the second generative AI as new generated information, and
a providing processing unit that provides the new generated information acquired by the acquisition processing unit or information based on the new generated information to the user as the response information.

10. The information processing apparatus according to claim 2, further comprising,
a determination unit that determines, when a single piece of generative AI has been selected from among the plurality of pieces of generative AI by the selection unit as the generative AI that is used to generate the response information, whether or not the response to the prompt is available by using past generated information that is information generated by using the single piece of generative AI in the past, and
a providing unit that provides, when it is determined by the determination unit that the response to the prompt is available by using the past generated information, the past generated information or information based on the past generated information to the user as the response information indicating the response to the prompt.

11. The information processing apparatus according to claim 10, wherein the providing unit includes
an acquisition processing unit that inputs, when it is determined by the determination unit that the response to the prompt is not available by using the past generated information, information including the prompt to the single piece of generative AI as input information, and that acquires the response information indicating the response to the prompt or information for generating the response information from the single piece of generative AI as new generated information, and
a providing processing unit that provides the new generated information acquired by the acquisition processing unit or information based on the new generated information to the user as the response information.

12. An information processing method executed by a computer, the information processing method comprising:
receiving a query including a prompt sent from a user or a query for obtaining the prompt;
selecting, based on information on a plurality of items included in the prompt, AI that is used to generate response information indicating a response to the prompt from among a plurality of pieces of AI; and
providing the response information that has been generated by using the AI selected at the selecting to the user.

13. A non-transitory computer readable storage medium having stored therein an information processing program that causes a computer to execute a process comprising:
receiving a query including a prompt sent from a user or a query for obtaining the prompt;
selecting, based on information on a plurality of items included in the prompt, AI that is used to generate response information indicating a response to the prompt from among a plurality of pieces of AI; and
providing the response information that has been generated by using the AI selected at the selecting to the user.
